(19) United States
(12) Patent Application Publication
(10) Pub. No.: US 2007/0234375 A1
(43) Pub. Date: Oct. 4, 2007

(54) DISC APPARATUS

(75) Inventor: Shinichi Fujisawa, Tokyo (JP)

Correspondence Address: DITTHAVONG MORI & STEINER, P.C., 918 Prince St., Alexandria, VA, 22314, US

(73) Assignee: TEAC CORPORATION, Tokyo (JP)

(21) Appl. No.: 11/686,756

(22) Filed: Mar. 15, 2007

(30) Foreign Application Priority Data
Mar. 29, 2006 (JP) 2006-092288

(51) Int. Cl. G11B 17/04; G11B 17/028

(52) U.S. Cl. 720/711; 720/623

(57) ABSTRACT

A disc apparatus capable of automatic loading to load a disc and to unload a disc includes a plurality of arms for supporting outer peripheral edges of two kinds of discs with different diameters so that two discs can be transported, a loading slider, a clamping head moved up and down a plurality of times to clamp a disc by the loading slider when the loading slider is repeatedly moved forward and backward and a spindle motor for rotating the clamping head, wherein the spindle motor is driven by driving force previously set in response to the kind of the inserted disc at a proper time of the clamping operation period and which period is a period before and/or after the loading slider is operated in the reverse direction to thereby rotate the disc at a predetermined angle.

### CROSS REFERENCES TO RELATED APPLICATIONS

The present application claims priority to Japanese Application No. P2005-092288 filed on Mar. 29, 2006, which application is incorporated herein by reference to the extent permitted by law.

### BACKGROUND OF THE INVENTION

1. Field of the Invention

The present invention relates to a drive apparatus for driving optical discs (for example, CD-R/RW, DVD-R/-RW/RAM/+R/RW, etc.) serving as recording mediums to record a large amount of information in information equipment such as various kinds of computer system.

2. Description of the Related Art

It is customary that a disc apparatus housed within a personal computer generally includes a disc tray to load therein discs, this disc tray being configured so that it can be moved in the forward and backward directions. Then, the disc loaded onto the disc tray is driven within the disc apparatus body to record or reproduce information.

On the other hand, there is a tendency that many slot-in system disc apparatus are used as a system without disc tray and these slot-in system disc apparatus are suitable for making a personal computer become thin and small. Since this slot-in system disc apparatus does not use a disc tray to carry a disc into the apparatus main body (load)/carry out a disc from the apparatus main body (unload), when an operator inserts the greater part of the disc into the slot, a loading mechanism of the apparatus main body can be operated so that discs can be automatically loaded onto the disc apparatus.

FIGS. 1 and 2 of the accompanying drawings are plan views showing an arrangement and operation modes of a loading mechanism in a slot-in system disc apparatus according to the related art. In the arrangement shown in FIGS. 1 and 2, when an operator inserts a disc D into the disc apparatus, the disc D reaches the position shown in FIG. 1 while its height direction and its right and left positions are being restricted by a pin 100a provided at a tip end of a first swing body 100 and right and left guide bodies 101 and 102. Then, the disc D reaches the position shown in FIG. 1 while it is also being restricted by a pin 103a provided at a tip end of a second swing body 103 in somewhere of the movement of the disc D.

At that time, the first swing body 100 is pushed at its pin 100a provided at the tip end by the disc D and thereby rotated in the direction shown by an arrow 100A. Also, the second swing body 103 also is pushed at its pin 103a provided at the tip end by the disc D and thereby rotated in the direction shown by an arrow 103A. Then, a switch lever 104 is pushed by the end portion of the second swing body 103 and thereby rotated in the direction shown by an arrow 104A to energize a detection switch 105.

When the above-described detection switch 105 is energized, a driving device 106 starts to operate to start moving a first slide member 107 in the direction shown by an arrow 107A. In the first and second slide members 107 and 108, respective tip ends thereof are joined together by a slide joint member 109 and this slide joint member 109 is pivotally supported by the pin 110 so as to swing so that the second slide member 108 is moved forwardly in the direction shown by an arrow 108A in synchronism with the backward movement of the first slide member 107.

As described above, when the first slide member 107 starts moving in the backward direction, in the first swing body 100, which is supported to this slide member 107 in a cantilever fashion, since its follower pin 100b is guided by a cam groove 107a of the first slide member 107, the first swing member 100 is rotated at a supporting point 100c in the direction shown by an arrow 100B, whereby a pin 100a provided at the tip end of the first swing body 100 is able to transport the disc D in the direction shown by an arrow 107A until it comes in contact with pins 111a and 111b of a disc positioning member 111.

At that time, since the pin 103a of the second swing body 103 is rotated in the direction shown by an arrow 103A, the pin 103a of the second swing body 103 is moved in the direction shown by the arrow 103A in synchronism with the pin 100a at the tip end of the first swing body 100 while supporting the disc D. Then, after the disc D was brought in contact with the pins 111a and 111b of the disc positioning member 111, the pin 103a of the second swing body 103 is rotated up to the position slightly distant from the disc D.

While operation modes in which the loading mechanism is operated when the disc D is loaded into the inside of the disc apparatus have been described so far, the loading mechanism is operated in operation modes opposite to the aforementioned operation modes when the disc D is unloaded to the outside of the disc apparatus. Specifically, as shown in FIG. 2, when the disc D is placed at a predetermined position within the disc apparatus, if the driving device 106 is started being driven in the reverse direction based on an unloading instruction, then the first slide member 107 starts moving forward in the direction shown by the arrow 107B and the second slide member 108 joined to the slide joint member 109 starts moving in the backward direction in synchronism with the first slide member 107. As a result, since the first swing body 100 is rotated in the direction shown by the arrow 100A and the second swing body 103 is rotated in the direction shown by the arrow 103B, the disc D is unloaded to the outside of the disc apparatus while it is being supported by the pins 100a and 103a provided at the tip ends of the first swing body 100 and the second swing body 103.

It should be noted that the disc D loaded into the inside of the disc apparatus may be clamped by a clamping head 112 which can be moved up and down at a predetermined position. This clamping head 112 is integrated with a turntable 113 fixed to a drive shaft of a spindle motor 114. Further, the above-described spindle motor 114 is disposed on a frame member (not shown) and this frame member can be moved in the upper and lower direction by an elevation mechanism (not shown) (for example, Patent Document 1).

As described above, when the disc is loaded into the inside of the apparatus, it becomes possible to clamp the central hole of the disc with the above-described clamping head by moving up and down the disc drive mechanism composed of the turntable including the clamping head and the spindle motor. The reason for this is that, as the frame member is moved in the upper direction, the clamping head is entered into the central hole of the disc and a chuck claw provided on the clamping head is engaged with the central hole of the disc to thereby hold the disc on the turntable.

In the disc apparatus in which the disc is clamped by the above-described apparatus, to chuck the central hole of the disc by the chuck claw with reliability becomes an important problem. More specifically, if a part of a plurality of chuck claws is placed in the state in which it is unable to chuck the central hole of the disc, then the disc is placed in the inclined state and it becomes unable to be kept in the horizontal state. There is a possibility that it will become impossible to reproduce information from the recording surface of the disc or to record information on the recording surface of the disc. Also, when the disc is dropped from the clamping state in the above-mentioned state, the loading mechanism becomes beyond its function range and it becomes impossible to unload the disc from the inside of the disc apparatus. As a consequence, it is inevitable that the disc is left in the inside of the disc apparatus and also there is a risk that the recording surface of the disc will be damaged.

[Patent Document 1]: Japanese Unexamined Patent Publication No. 2005-85449

### SUMMARY OF THE INVENTION

There is a large provability that the aforementioned shortcoming will occur in a disc in which a stepped portion d1 is formed on a central hole Da of the disc D as shown in FIG. 3A, a disc in which a groove d2 is formed in the central hole Da of the disc D as shown in FIG. 3B or a disc having a multilayer of recording layers in which a groove d3 formed of an intermediate layer is formed in the disc hole Da of the disc D as shown in FIG. 3C.

Also, two kinds of discs with different diameters which are target discs of the present invention are generally referred to as a 12-cm disc and a 8-cm disc and the 12-cm disc is highest in general-purpose properties. Mechanisms for automatically loading any of the 12-cm disc and the 8-cm disc so that it can be driven are extremely complex in arrangement. Accordingly, in order to recover a disc left within the disc apparatus after a defect occurred when the disc is clamped, first, electronic equipment having a disc apparatus incorporated therein should be disassembled, the thus removed disc apparatus should further be disassembled and the remaining disc should be recovered finally.

In view of the aforesaid aspects, the present invention intends to provide a disc apparatus in which any of two kinds of discs, that is, a disc-like large-diameter disc and a disc-like small-diameter disc can be driven and in which any of the above discs automatically loaded onto the disc apparatus can be clamped on a turntable with reliability.

Therefore, according to the present invention, the above-described problems can be solved by the following devices. That is, according to the invention claimed in claim 1, there is provided a disc apparatus capable of automatic loading to load a disc into the inside of the apparatus and to unload a disc accommodated within the disc to the outside of the apparatus. This disc apparatus includes a plurality of arms for supporting outer peripheral edges of two kinds of discs with different diameters so that the two discs can be transported, a loading slider, a clamping head moved up and down a plurality of times to clamp a disc by the loading slider when the loading slider is repeatedly moved forward and backward and a spindle motor for rotating the clamping head. In this disc apparatus, the spindle motor is driven by driving force previously set in response to the kind of the inserted disc at a proper time of said clamping operation period and which period is a period before and/or after the loading slider is operated in the reverse direction to thereby rotate the disc at a predetermined angle.

According to claim 2 of the invention, in the invention claimed in claim 1, the driving force of the spindle motor is set based on a voltage value of a voltage applied to the spindle motor and/or duration of time in which a voltage is applied to the spindle motor.

According to claim 3, the invention claimed in claim 1 further comprises a switch for identifying the kind of an inserted disc and in which driving force to drive the spindle motor when the clamping head clamps a disc is selected based on an output signal from the switch.

According to claim 4 of the invention, there is provided a disc apparatus capable of automatic loading to load a disc into the inside of the apparatus and to unload a disc accommodated within the disc to the outside of the apparatus. This disc apparatus includes a plurality of arms for supporting outer peripheral edges of two kinds of discs with different diameters so that the two discs can be transported, a chassis case, a loading slider, a clamping head moved up and down a plurality of times to clamp a disc by the loading slider when the loading slider is repeatedly moved forward and backward and a spindle motor for rotating the clamping head. In this disc apparatus, when a clamping operation to move a disc away from a chassis case by lowering the clamping head after a disc was urged against the chassis case by elevating the clamping head is carried out a plurality of times, the spindle motor for rotating the clamping head is driven by driving force previously set in response to the kind of an inserted disc to rotate a disc at a predetermined angle at a proper time of the clamping period and which is a period in which a disc is spaced apart from the chassis case.

According to the present invention, in a slot-in system disc apparatus capable of automatically loading any of two kinds of disk-like discs with different diameters so that the loaded disc can be driven, the disc automatically loaded can be clamped with reliability and it is possible to reliably prevent a defect in which a disc is left within the apparatus.

### BRIEF DESCRIPTION OF THE DRAWINGS

FIG. 1 is a plan view showing a disc apparatus according to the related art;

FIG. 2 is a plan view showing a disc apparatus according to the related art;

FIGS. 3A, 3B and 3C are diagrams to which reference will be made in explaining forms of central holes of the discs according to the related art, respectively;

FIG. 4 is a perspective view showing a slot-in system disc apparatus according to an embodiment of the present invention;

FIG. 5 is a perspective view showing an arrangement of the inside of the disc apparatus show in FIG. 4;

FIG. 6 is a perspective view showing an arrangement of a drive mechanism of the disc apparatus shown in FIG. 4;

FIG. 7 is an exploded perspective view showing an arrangement of a loading slider;

FIG. 8 is an exploded perspective view showing arrangements of the loading slider and a guide plate;

FIG. 9 is an exploded perspective view showing an arrangement of a power transmission mechanism;

FIG. 10 is an exploded perspective view showing an arrangement of a gear disc;

FIG. 11 is a perspective view showing an arrangement of a rack slider;

FIG. 12 is a first process diagram useful for explaining a state in which a large-diameter disc is being transported;

FIG. 13 is a second process diagram useful for explaining a state in which a large-diameter disc is being transported;

FIG. 14 is a third process diagram useful for explaining a state in which a large-diameter disc is being transported;

FIG. 15 is a fourth process diagram useful for explaining a state in which a large-diameter disc is being transported;

FIG. 16 is a fifth process diagram useful for explaining a state in which a large-diameter disc is being transported;

FIG. 17 is a sixth process diagram useful for explaining a state in which a large-diameter disc is being transported;

FIG. 18 is a seventh process diagram useful for explaining a state in which a large-diameter disc is being transported;

FIG. 19 is a first process diagram useful for explaining a state in which a large-diameter disc is being transported;

FIG. 20 is a second process diagram useful for explaining a state in which a large-diameter disc is being transported;

FIG. 21 is a third process diagram useful for explaining a state in which a large-diameter disc is being transported;

FIG. 22 is a fourth process diagram useful for explaining a state in which a large-diameter disc is being transported;

FIG. 23 is a fifth process diagram useful for explaining a state in which a large-diameter disc is being transported;

FIG. 24 is a sixth process diagram useful for explaining a state in which a large-diameter disc is being transported;

FIG. 25 is a seventh process diagram useful for explaining a state in which a large-diameter disc is being transported;

FIG. 26 is a first process diagram useful for explaining a state in which a small-diameter disc is being transported;

FIG. 27 is a second process diagram useful for explaining a state in which a small-diameter disc is being transported;

FIG. 28 is a third process diagram useful for explaining a state in which a small-diameter disc is being transported;

FIG. 29 is a fourth process diagram useful for explaining a state in which a small-diameter disc is being transported;

FIG. 30 is a fifth process diagram useful for explaining a state in which a small-diameter disc is being transported;

FIG. 31 is a sixth process diagram useful for explaining a state in which a small-diameter disc is being transported;

FIG. 32 is a seventh process diagram useful for explaining a state in which a small-diameter disc is being transported;

FIG. 33 is a first process diagram useful for explaining a state in which a small-diameter disc is being transported;

FIG. 34 is a second process diagram useful for explaining a state in which a small-diameter disc is being transported;

FIG. 35 is a third process diagram useful for explaining a state in which a small-diameter disc is being transported;

FIG. 36 is a fourth process diagram useful for explaining a state in which a small-diameter disc is being transported;

FIG. 37 is a fifth process diagram useful for explaining a state in which a small-diameter disc is being transported;

FIG. 38 is a sixth process diagram useful for explaining a state in which a small-diameter disc is being transported;

FIG. 39 is a seventh process diagram useful for explaining a state in which a small-diameter disc is being transported;

FIGS. 40A to 40E are respectively process diagrams useful for explaining processes in which an elevation frame is being ascended;

FIGS. 41A to 41E are respectively process diagrams useful for explaining processes in which the elevation frame is descended;

FIGS. 42A, 42B and 42C are respectively diagrams useful for explaining modes in which a gear disc is operated;

FIGS. 43A to 43D are respectively process diagrams useful for explaining modes in which an arm is operated when the large-diameter disc is transported;

FIGS. 44A to 44D are respectively process diagrams useful for explaining modes in which a loading arm is operated;

FIGS. 45A to 45F are respectively process diagrams useful for explaining modes in which a loading slider and a follower pin are operated;

FIGS. 46A and 46B are respectively process diagrams showing states in which a lock lever functions;

FIG. 47 is a diagram useful for explaining operation modes of the present invention;

FIG. 48 is a diagram useful for explaining operation modes of the present invention;

FIGS. 49A to 49D are respectively diagrams useful for explaining functions of the present invention;

FIG. 50 is a plan view showing an arrangement of a main portion of the present invention;

FIG. 51 is a perspective view showing an arrangement of a main portion of the present invention in an enlarged-scale;

FIG. 52 is a plan view showing an arrangement of a main portion of the present invention;

FIG. 53 is a diagram showing states of signals generated when a large-diameter disc is loaded onto a disc apparatus; and

FIG. 54 is a diagram showing states of signals generated when a small-diameter disc is loaded onto a disc apparatus.

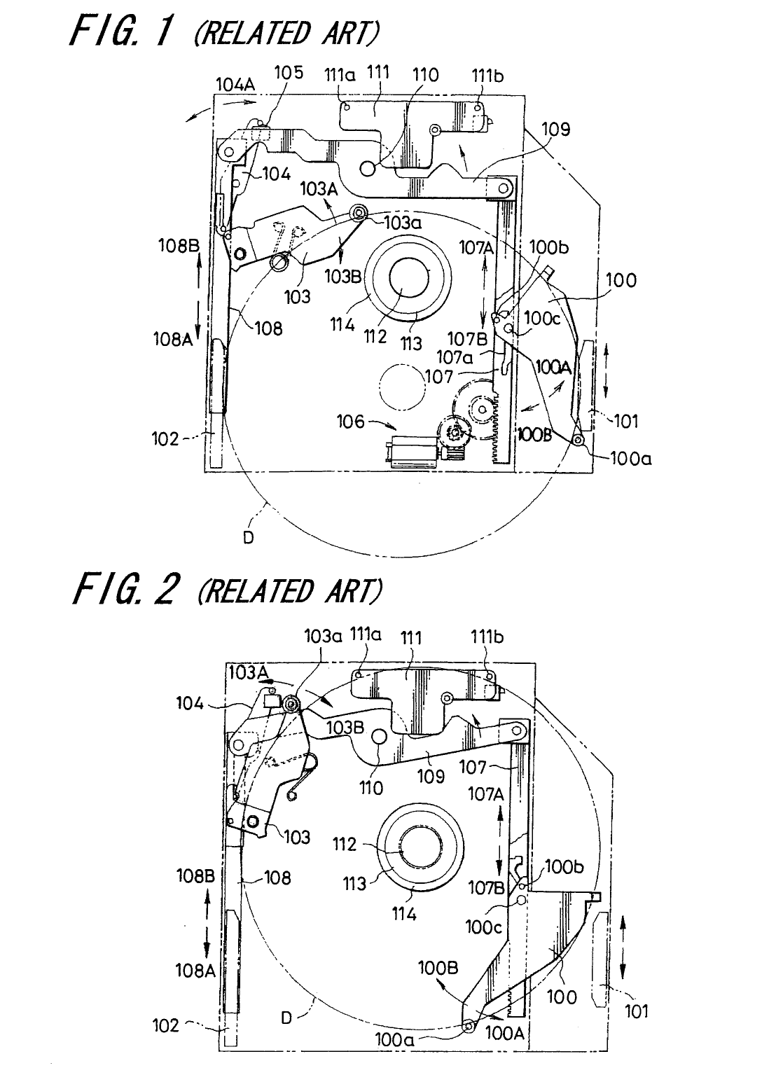

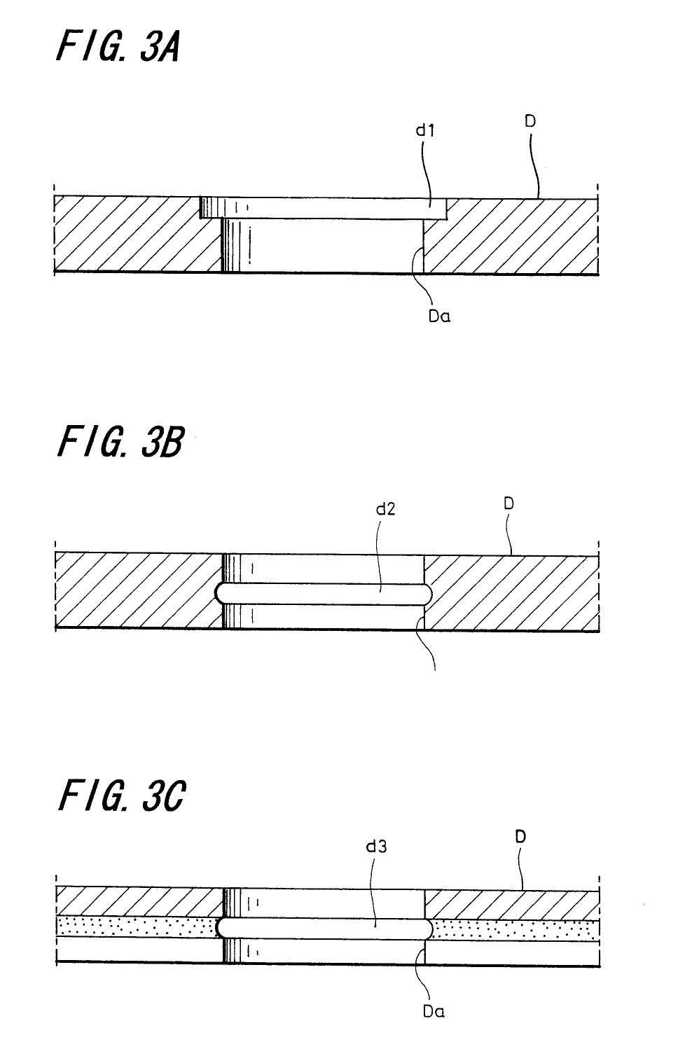

### DESCRIPTION OF THE PREFERRED EMBODIMENTS

Preferred embodiments of the present invention will be described below in detail with reference to the drawings. It should be noted that the present invention will be described together with arrangements relating to the gist of the present invention in order to facilitate understanding of the present invention.

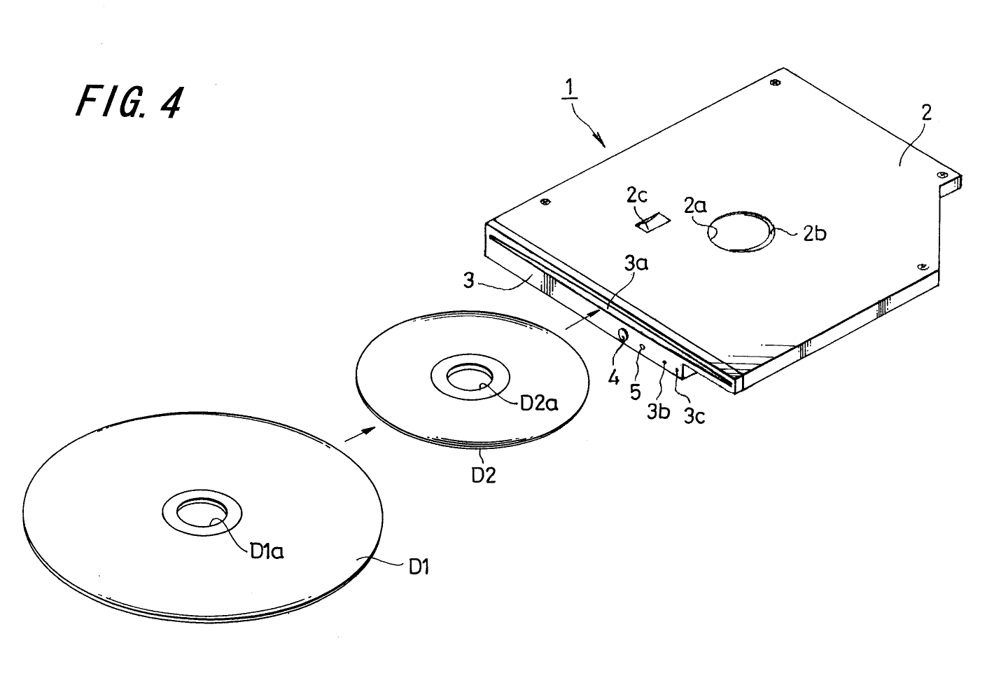

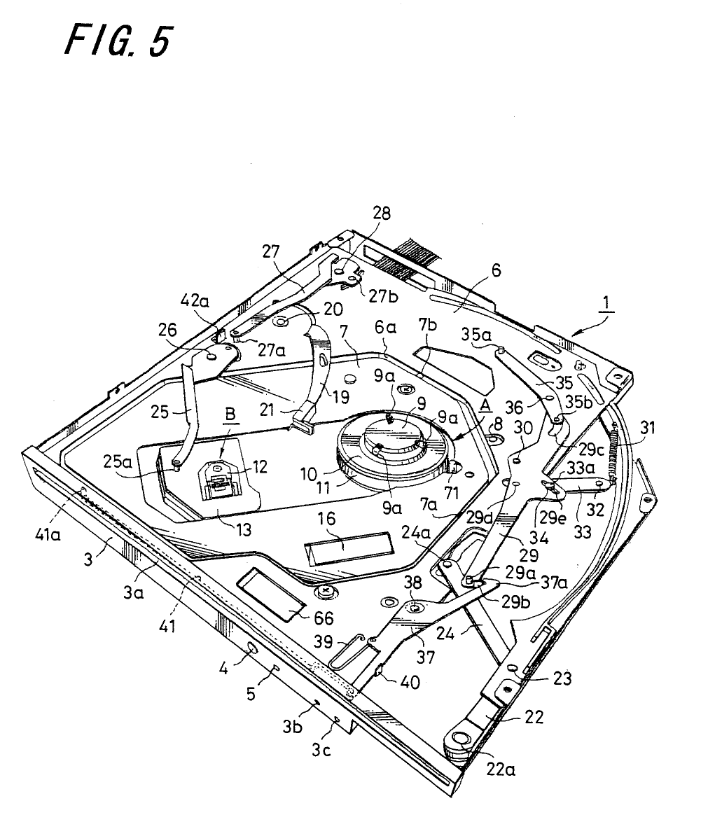

FIG. 4 is a perspective view showing an outward appearance of a slot-in system disc apparatus 1 according to the present invention. As shown in FIG. 4, an opening 2a is defined at the center of a top cover of a chassis case 2 which is configured in the shield state. A protruded portion 2b that is protruded to the inside is formed at the peripheral edge portion of this opening 2a. A front bezel 3 is fixed to the front end of the chassis case 2, and this front bezel 3 has a slot 3a to insert a 12 cm-disc (hereinafter referred to as a “large-diameter disc”) D1 and a 8 cm-disc (hereinafter referred to as a “small-diameter disc) D2 and through-holes 3b and 3c to release emergency. Also, the front bezel 3 includes a push-button 4 to unload the accommodated large-diameter disc D1 or small-diameter disc D2 to the outside of the disc apparatus 1 and an indicator 5 to indicate the operating state of the disc apparatus 1.

FIG. 5 is a perspective view showing a state in which the top cover portion was removed from the above-described chassis case 2. As shown in FIG. 5, a base panel 6 is located within the chassis case 2 and a driving unit A for driving the large-diameter disc D1 and the small-diameter disc D2 is provided on the base panel 6 such that it is located from the center to the oblique lower direction. In this driving unit A, an elevation frame 7 using the side of the front bezel 3 as a supporting axis and of which rear end portion located at the center of the disc apparatus 1 can swing in the upper and lower direction is joined to the base panel 6 at a plurality of places by a known shock-absorbing support structure 8 in order to clamp central holes D1a and D2a of the large-diameter disc D1 and the small-diameter disc D2 or to release the large-diameter disc D1 and the small-diameter disc D2 from the clamped state.

A clamping head 9 is located on the tip end of the above-described elevation frame 7 at its position corresponding to the center of the large-diameter disc D1 or the small-diameter disc D2 which was transported and came to an end. This clamping head 9 is integrally formed with a turntable 10 and fixed to a drive shaft (not shown) of a spindle motor 11 located just under the turntable 10. This spindle motor 11 rotates the large-diameter disc D1 or the small-diameter disc D2 clamped by a chucking claw 9a of the clamping head 9 to record or reproduce information.

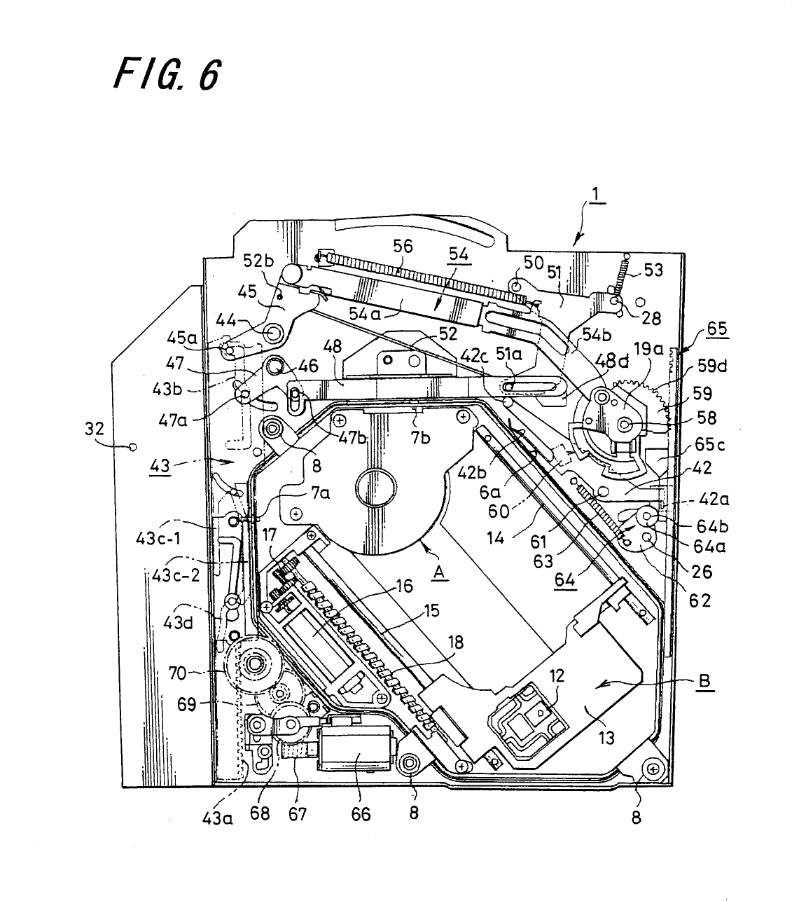

Reference letter B denotes a head unit supported to the elevation frame 7 and a carrier block 13 for reciprocally moving the large-diameter disc D1 and the small-diameter disc D2 in the diameteric direction is supported to guide shafts 14 and 15 of which both ends are fixed to the elevation frame 7. Then, the above-described carrier block 13 is moved forward and backward by driving force transmitted from a gear train 17 to a screw shaft 18 (see FIG. 6).

Next, a plurality of arms for loading and unloading the large-diameter disc D1 and the small-diameter disc D2 onto and from the disc apparatus 1 are provided on the flat surface of the base panel 6 so as to surround the elevation frame 7 and they are configured in such a manner that they may be operated by a driving mechanism provided on the back surface of the base panel 6. Of a plurality of arms, a disc supporting arm 19 performs a central function to load and unload the large-diameter disc D1 and the small-diameter disc D2 onto and from the disc apparatus 1. This disc supporting arm 19 is able to swing at a rivet pin 20 to support the rear end sides of the large-diameter disc D1 and the small-diameter disc D2 and it is able to keep the height positions of the large-diameter disc D1 and the small-diameter disc D2 with high accuracy in the transporting process. To this end, the disc supporting arm 19 has a holder 21 provided at its tip end and a concave groove 21a of this holder 21 can hold the rear end sides of the large-diameter disc D1 and the small-diameter disc D2.

Reference numeral 22 denotes a loading arm to load the large-diameter disc D1 into the disc apparatus 1. This loading arm 22 is pulled by a link lever 24 joined by a pivot pin 23 and thereby swung. Thus, the loading arm 22 functions such that it starts pressing the large-diameter disc D1 inserted by its loading roller 22a from the front side portion of the center to guide the large-diameter disc D1 into the disc apparatus 1.

A guide arm 25 can swing at a pivot pin 26 rotatably attached to the base panel 5 and functions to support the side portion of the small-diameter disc D2 transported by a supporting member 25a fixed to the tip end of the guide arm 25 in a hanging-down fashion to guide the small-diameter disc D2 to a predetermined position. Also, a guide arm 27 can swing at a rivet pin 28 and functions to support the side portion of the large-diameter disc D1 transported by a supporting member 27a fixed to the tip end of the guide arm 27 in a hanging-down fashion to guide the large-diameter disc D1 to a predetermined position. The guide arm 27 functions also to support the side portion of the small-diameter disc D2 to guide the small-diameter disc D2 to a predetermined position. This guide arm 27 has a pivot pin 27b provided at its base end portion. An end portion of a third swing member 51 and an end portion of a tension coil spring 53 are attached to the pivot pin 27b at the back surface of the base panel 6.

A guide arm 29 is able to swing at a rivet pin 30 and functions to support the side portion of the small-diameter disc D2 transported by a supporting member 29a fixed to the tip end of the guide arm 29 in an erecting fashion to thereby guide the small-diameter disc D2 to a predetermined position. Also, the guide arm 29 functions to support the large-diameter disc D1 to properly position the large-diameter disc D1 to a predetermined position. It should be noted that, since an action pin 33a of a link lever 33 that swings at the rivet pin 32 under spring force of the tension coil spring 31 is engaged with a slit 29e of the above-described guide arm 29, the tip end of the guide arm 29 is constantly spring-biased in the centripetal direction. A guide arm 35 joined to a guide groove 29c at the rear end portion of the above-described guide arm 29 by a follower pin 35b is able to swing at a rivet pin 36 so that it may function to support the rear end side of the small-diameter disc D2 by a supporting member 35a fixed to the tip end of the guide arm 35 in an erected state to thereby guide the small-diameter disc D2 to a predetermined position and that it also functions to support the side portion of the small-diameter disc D2 to thereby properly position the small-diameter disc D2 at a predetermined position.

Reference numeral 37 denotes a lock lever 37 and this lock lever 37 is able to swing at a rivet pin 38 such that an angle 37a formed at the tip end of the lock lever 37 can lock a strip piece 29b provided at the tip end of the above-described guide arm 29. Although this lock lever 37 is constantly spring-biased at its angle 37a provided at its tip end in the centripetal direction by a wire spring 39, it is usually placed in the static state at a predetermined position owing to a function of a stopper 40.

Reference numeral 41 denotes a lead wire extended along the lower side of the front bezel 3. An end portion of the lead wire 41 is joined to the rear end portion of the above-described lock lever 37 and an engagement end portion 41a thereof is bent in an erected fashion so as to face to the slot 3a of the front bezel 3. Accordingly, when the large-diameter disc D1 is inserted into the disc apparatus 1 from the slot 3a, since the above-described engagement end portion 41a is pressed by the side portion of the large-diameter disc D1, this lead wire 41 is moved in the lateral direction in parallel to the front bezel 3. As a result, the lock lever 37 is pulled and the angle 37a at the tip end of the lock lever 37 is swung in the centrifugal direction so that the strip piece 29b of the guide arm 29 can be avoided from being locked.

It should be noted that, in the mechanism elements exposed on the flat surface of the base panel 6, reference numeral 42a denotes a locking strip piece of a lever arm (see FIGS. 5 and 6). While this locking strip piece 42a may function to control the position of the guide arm 27, operation modes thereof will be described in detail later on. Also, reference numeral 71 denotes a clamp releasing pin to release the large-diameter disc D1 and the small-diameter disc D2 from being clamped by the clamping head 9.

Mechanism elements configured on the back surface of the base panel 6 in order to operate various mechanism elements such as respective guide arms configured on the flat surface of the base panel 6 as described above will be described below. The disc apparatus 1 according to the present invention is configured in such a manner that all operation controls concerning the transport of the large-diameter disc D1 and the small-diameter disc D2 can be completed by forward and backward movements of a loading slider 43 located within the side portion of the disc apparatus 1 in the front and back direction as shown by an imaginary line in FIG. 6. An arrangement of the loading slider 43 that becomes the center of the mechanism elements and respective mechanism elements of which operations are controlled by this loading slider 43 will be described.

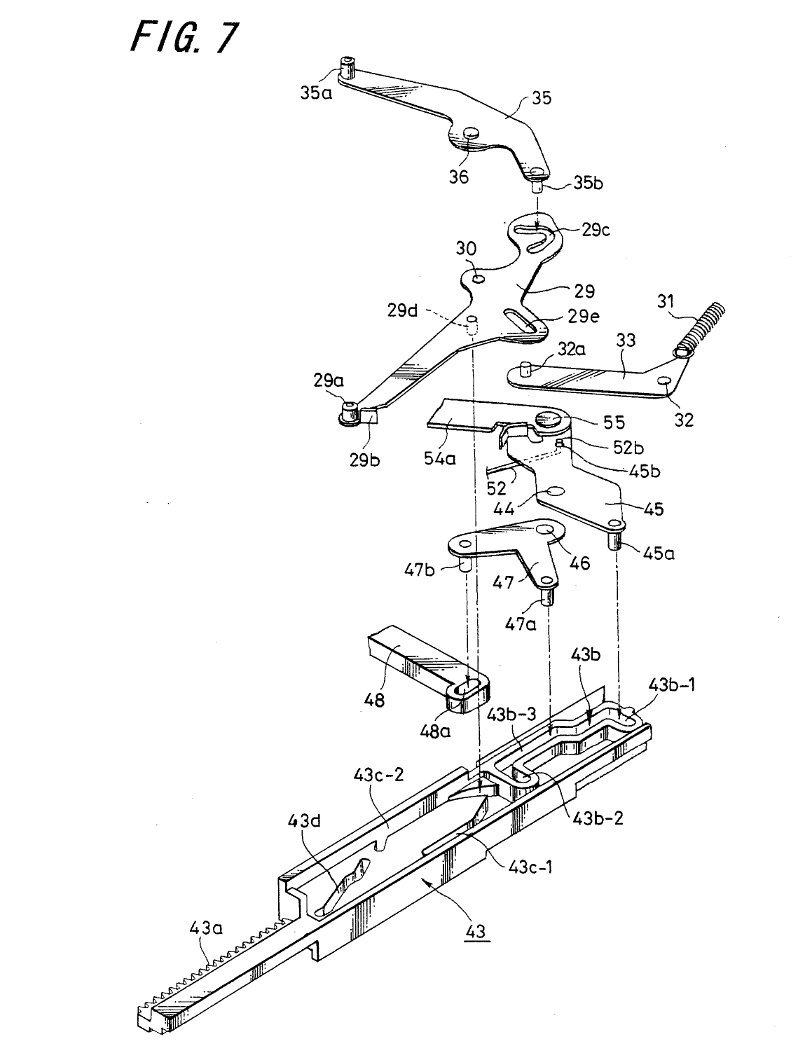

FIG. 7 is an exploded perspective view showing the states of the above-mentioned mechanism elements from the direction in which the loading slider 43 is opposed to the back surface of the base panel 6. As shown in FIG. 7, the loading slider 43 is shaped like a pillar and a rack gear 43 is formed at its front end portion. On the other hand, the loading slider 43 has at its rear end portion formed a guide groove 43b with which an upper end horizontal portion 43b-1, a lower-end horizontal portion 43b-2 and a vertical portion 43b-3 having a stepped portion at its middle portion are communicated.

A follower pin 45a of a first swing member 45 that can swing at a rivet pin 44 is attached to the above-described upper end horizontal portion 43b-1 and a follower pin 47a of a second swing member 47 that can swing at a rivet pin 46 is attached to the vertical portion 43b-3. Then, an action pin 47a of this second swing member 47 is attached to an end portion through-hole 48a of a follower slider 48.

Guide grooves 43c-1 and 43c-2 are formed at both sides of a middle position portion of the loading slider 43. An inclined surface is formed on the rear end portion of the guide groove 43c-1 and the front and rear ends of the guide groove 43c-2 also are inclined. Then, the follower pin 29d of the above-described guide arm 29 is placed at the opening portion of the rear end inclined portion of the above-described guide groove 43c-2 in the state in which the loading slider 43 is moved most in the forward direction.

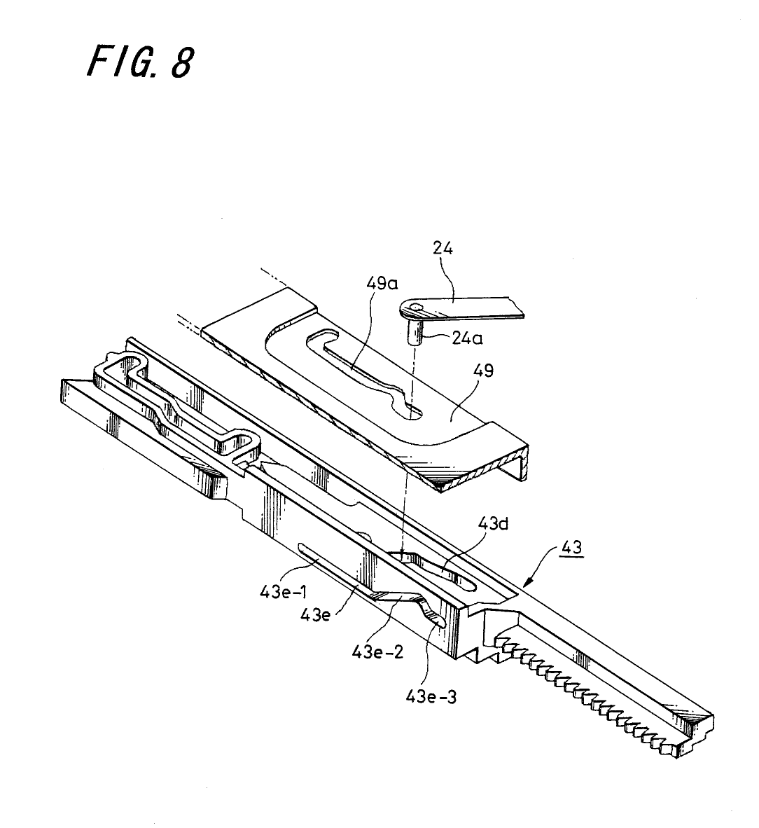

Reference numeral 43d denotes a guiding groove to pull the link lever 24 in such a manner that the loading arm 22 may be operated in synchronism with the transport of the large-diameter disc D1. As shown in FIG. 8, a guide slit 49a is formed on a guide plate 49 fixed to the base panel 6 located at the position in which it is put on this guiding groove 43d and the follower pin 24a fixed to the tip end of the link lever 24 is inserted into the guiding groove 43d and the guide slit 49a. Accordingly, the guide slit 49a placed at a predetermined position can act relative to the guiding groove 43d which is moved forward and backward to thereby control operations of the above-described follower pin 24a.

Also, a cam groove 43e to move the follower pin 7a, which can ascend and descend this elevation frame 7, in the upper and lower direction is formed on the side portion which faces the elevation frame 7 of the loading slider 43. This cam groove 43e is composed of a series of a low position portion 43e-1 to keep the elevation frame 7 at the low position, an inclined portion 43e-2 to ascend or descend the elevation frame 7 and a high position portion 43e-3 to keep the elevation frame 7 at the high position.

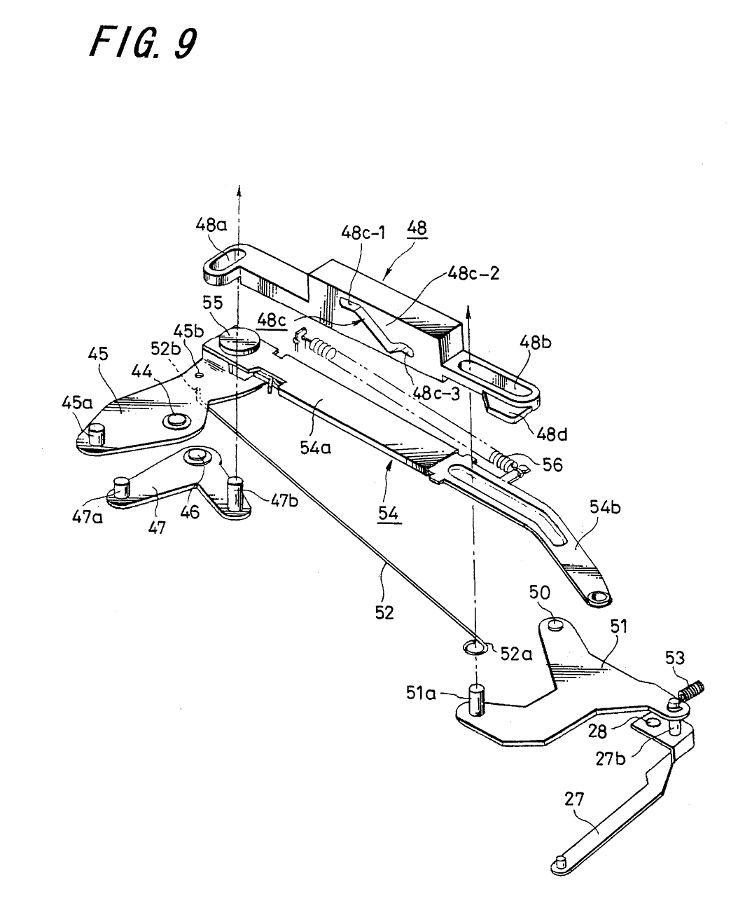

FIG. 9 is an exploded perspective view showing a power transmission mechanism configured at the rear portion within the disc apparatus 1 from the back surface. As shown in FIG. 9, this power transmission mechanism includes a cam groove 48c that can move up and down the follower pin 7b which functions to ascend and descend the elevation frame 7 of the follower slider 48. This cam groove 48c is composed of a series of a low position portion 48c-1 to keep the elevation frame 7 at the low position, an inclined portion 48c-2 to ascend or descend the elevation frame 7 and a high position portion 48c-3 to keep the elevation frame 7 at the high position.

The above-described follower slider 48 includes an end portion through-hole 48b into which an action pin 51a of a third swing member 51 that can swing at a rivet pin 50 is fitted. Then, an end portion 52a of a link wire 52 is attached to the above-described action pin 51a and the other end portion 52b is engaged with the through-hole 45b of the first swing member 45. While the above-described third swing member 51 is spring-biased in the counter-clockwise direction in FIG. 9 under spring force of the tension coil spring 53, the action pin 51a is limited in action by the link wire 52 so that the third swing member 51 is placed in the static state at a predetermined position in the state in which the disc apparatus 1 is not operated. Also, an action piece 48d to operate the lever arm 42 is formed at the side portion of the above-described end portion through-hole 48b.

Next, a link arm 54 joined between the first swing member 45 and a gear disc 59, which will be described later on, can be configured so as to be contracted and expanded by a combination of a first link arm 54a joined to the first swing member 45 by a joint member 55 and a second link arm 54b spring-biased under spring force of a tension coil spring 56, thereby making it possible to secure safety of the mechanism when the large-diameter disc D1 and the small-diameter disc D2 are transported.

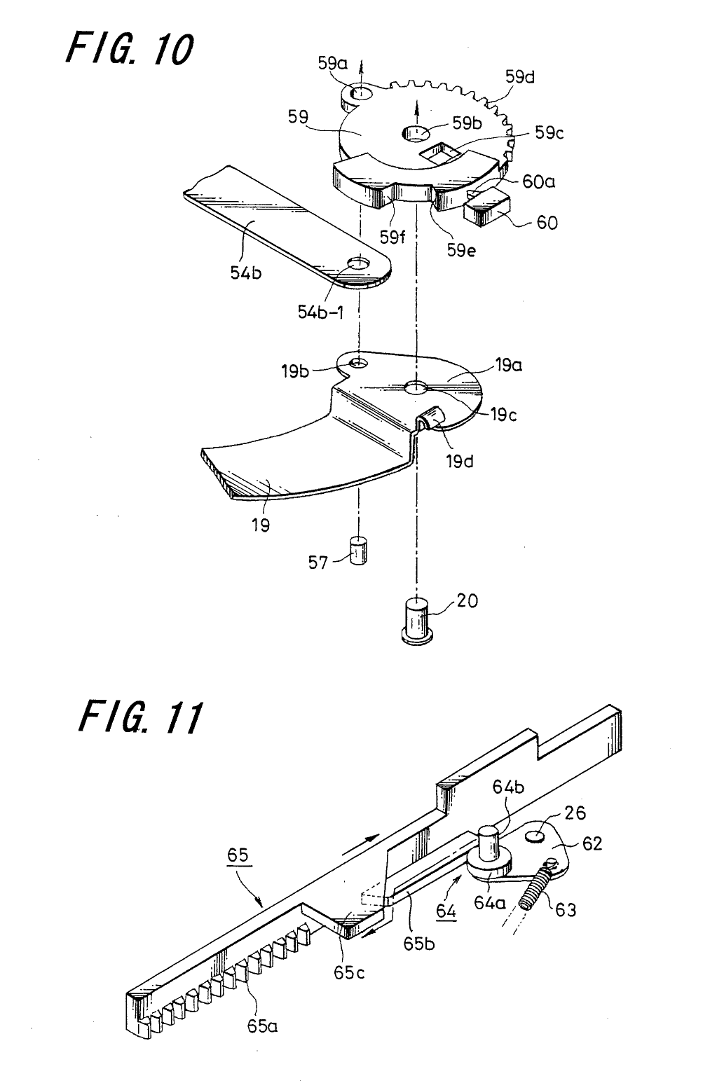

FIG. 10 is a perspective view showing an arrangement of an end portion of the above-described second link arm 54b from the back surface of the disc apparatus 1, wherein a through-hole 54b-1 of the second link arm 54b, the through-hole 19b of the rotary base plate 19a of the disc supporting arm 19 and a through-hole 59a of a gear disc 59 are pivotally supported to the end portion of the second link arm 54 by a pivot pin 57 so as to become rotatable at the same time. On the other hand, the central hole 19c of the disc supporting arm 19 and a central hole 59b of the gear disc 59 are pivotally supported at the same time by the rivet pin 20 of which one end is fixed to the base panel 6 and the engagement piece 19d of the above-described rotary base plate 19a is opposed to an engagement window 59c of the gear disc 59, thereby being integrated as one body.

A gear 59d is formed at a part of an outer peripheral edge opposing to the side surface of the chassis case 2 of the above-described gear disc 59 and switch actuating stepped portions 59e and 59f are formed on the opposing outer peripheral edge. A limit switch 60, which is energized by the above-described switch actuating stepped portions 59e and 59f, is mounted on a wiring board (not shown) disposed on the bottom surface of the chassis case 2 and its switch knob 60a is operated by the above-described switch actuating stepped portions 59e and 59f.

The aforementioned lever arm 42 is fixed so as to swing at a rivet pin 61. Its locking strip piece 42a is faced to the surface of the base panel 6 from the opening of the base panel 6 and the tip end of the spring piece 42b is brought in contact with the opening wall 6a of the base panel 6, whereby spring-biasing force in the centrifugal direction is generated in the roller 42c formed at the tip end portion of the lever arm 42. As a result, although the lever arm 42 is placed in the static state at a predetermined position when the roller 42c is brought in contact with the side wall of the follower slider 48, if the follower slider 48 is slid, then its action piece 48d is pressed by the roller 42c so that the lever arm 42 is swung at a rivet pin 61, thereby causing the locking strip piece 42d to be moved in the centrifugal direction.

Next, a mechanism by which the guide arm 25 can be swung will be described. In this guide arm 25, the pivot pin 26 provided at the base end of the guide arm 25 so as to serve as its swing supporting point is extended on the rear surface of the base panel 6 and a roller supporting plate 62 is fixed to the end portion of the pivot pin 26. Since this roller supporting plate 61 has a tension coil spring 63 extended therein as shown in FIG. 6, it is spring-biased in the clockwise direction in FIG. 6 under spring force of the tension coil spring 63, whereby the guide arm 25 is inclined in the centripetal direction. A double roller 64 disposed on the above-described roller supporting plate 62 is composed of a large-diameter portion 64a and a small-diameter portion 64b which are configured on the same axis as shown in FIG. 11.

In FIG. 11, a rack slider 65 provided along the inner surface of the side wall of the chassis case 2 includes a rack gear 65a meshed with the gear 59d of the gear disc 59 so that the rack slider 65 may be moved forward and backward in synchronism with rotation of the gear disc 59. A low position guide piece 65b is formed on the lower side of the intermediate portion of the rack slider 65 and a high position guide piece 65c is formed on the high side of the intermediate portion of the rack slider 65. The low position guide piece 65b may guide the large-diameter portion 64a of the above-described double roller 64 and the high position guide piece 65c may guide the small-diameter portion 64b.

While the thus configured mechanism elements are operated as the loading slider 43 is slid forward and backward, this drive mechanism is provided at the corner portion of the back surface of the disc apparatus 1 as shown in FIG. 6. Rotational force of a worm gear 67 of an output shaft of a loading motor 66 that serves as a power source of the drive mechanism is decelerated and transmitted to small-diameter gears to large-diameter gears, in that order, by a gear train composed of double gears 68, 69 and 70. Then, driving force is transmitted to the loading slider 43 from a small-diameter gear of the double gear 70 meshed with the rack gear 43a of the loading slider 43 and thereby the loading slider 43 is slid in the forward and backward direction.

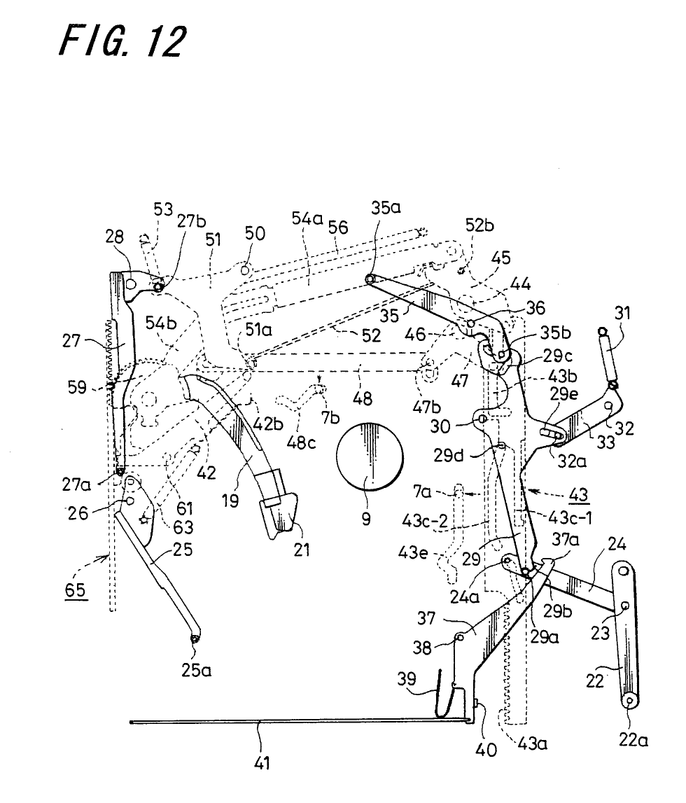

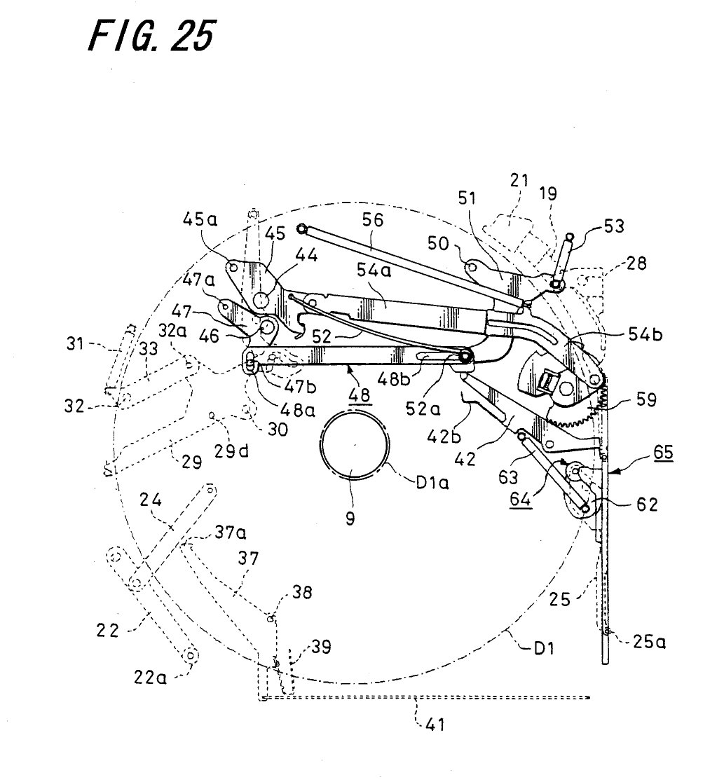

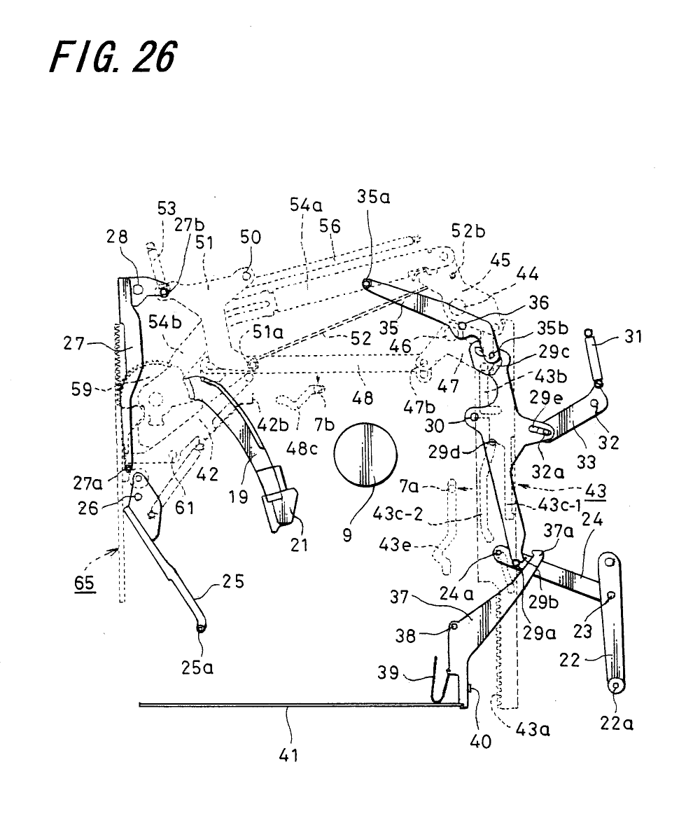

Next, operation modes of the disc apparatus 1 according to the present invention having the above-mentioned arrangement will be described. As described above, the disc apparatus 1 is configured such that the large-diameter disc D1 and the small-diameter disc D2 can be transported. First, the transport modes of the large-diameter disc D1 will be described with reference to FIGS. 12 to 25 and the transport modes of the small-diameter disc D2 will be described with reference to FIGS. 26 to 39.

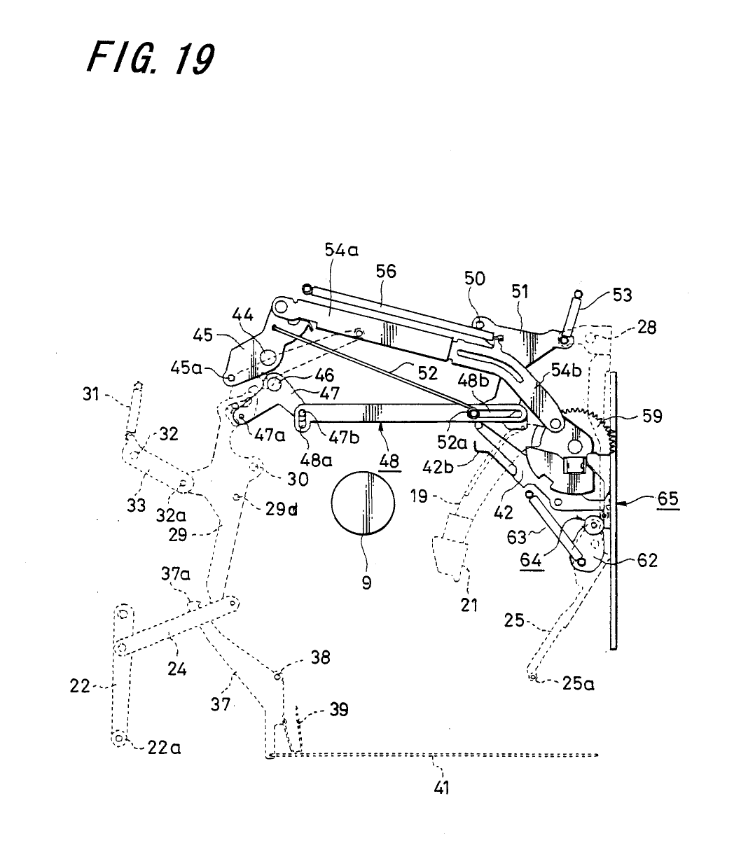

FIGS. 12 to 18 are plan views showing main portions of the arrangements exposed on the surface of the base panel 6 by solid lines. Main portions of the arrangements exposed on the back surface of the base panel 6 at that time are shown by broken lines in FIGS. 12 to 18. Also, FIGS. 19 to 25 are bottom views showing main portions of the arrangements exposed on the back surface of the base panel 6 by solid lines. Arrangements exposed on the surface of the base panel 6 at that time are shown by broken lines in FIGS. 19 to 25. It should be noted that, although the cam grooves 43e, 48c and the follower pins 7a, 7b are inherently not shown in FIGS. 12 to 18, they are shown in FIGS. 12 to 18 in order to understand the present invention more easily.

FIGS. 12 and 19 show states in which the disc apparatus 1 is placed in the standby state to await the insertion of the large-diameter disc D1 from the slot 3a of the front bezel 3 and in which respective arms are placed in the static state in the initial state. At that time, in the guide arm 25, the large-diameter portion 64a of the double roller 64 of the roller supporting plate 62 fixed to the above-described pivot pin 26 at the back surface of the base panel 6 is brought in contact with the low position guide piece 65b of the rack slider 65 as shown in FIGS. 11 and 19 so that the guide arm 25 is stopped at the position swung in the centrifugal direction by a predetermined amount from the position at which it is swung most in the centripetal direction.

The reason for this will be described below. If the disc apparatus 1 is configured such that it awaits the insertion of the disc when the guide arm 25 is stopped at the position in which it is swung most in the centrifugal direction, then when the small-diameter disc D2 is displaced to the left-hand side and inserted into the disc apparatus 1, the small-diameter disc D2 is entered into the left-hand side of the supporting member 25a so that it may become impossible to transport the small-diameter disc D2. In order to prevent this disadvantage, the guide arm 25 is stopped at the position in which it is swung by a predetermined amount in the centrifugal direction from the position at which it is swung most in the centripetal direction.

Next, since the guide arm 27 is spring-biased at its base end portion under spring force of the tension coil spring 53, it is constantly applied with force to swing the supporting member 27a provided at the tip end of the guide arm 27 in the centripetal direction. However, the third swing member 51 joined to the pivot pin 27b is placed in the static state at a predetermined position and hence this guide arm 27 is placed in the static state in the state shown in FIG. 12. This is because the link wire 52 attached between the first swing member 45 in the stationary state and the action pin 51a of the third swing member 51 functions as a stopper to prevent the third swing member 51 from swinging.

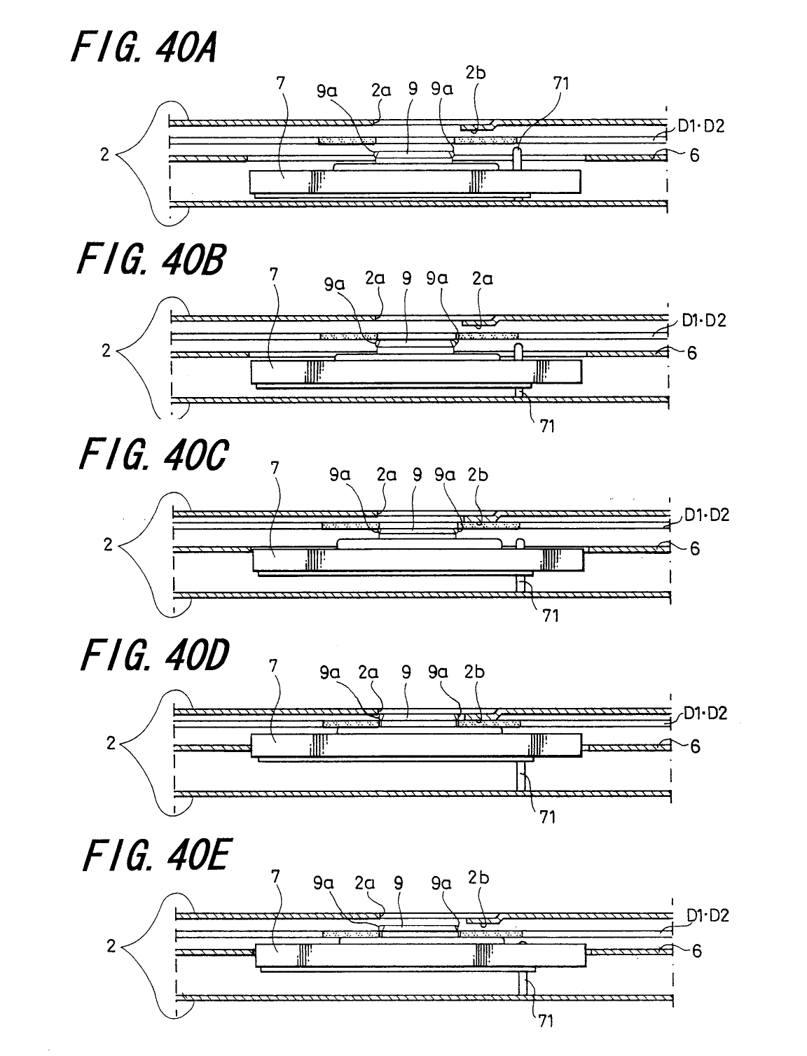

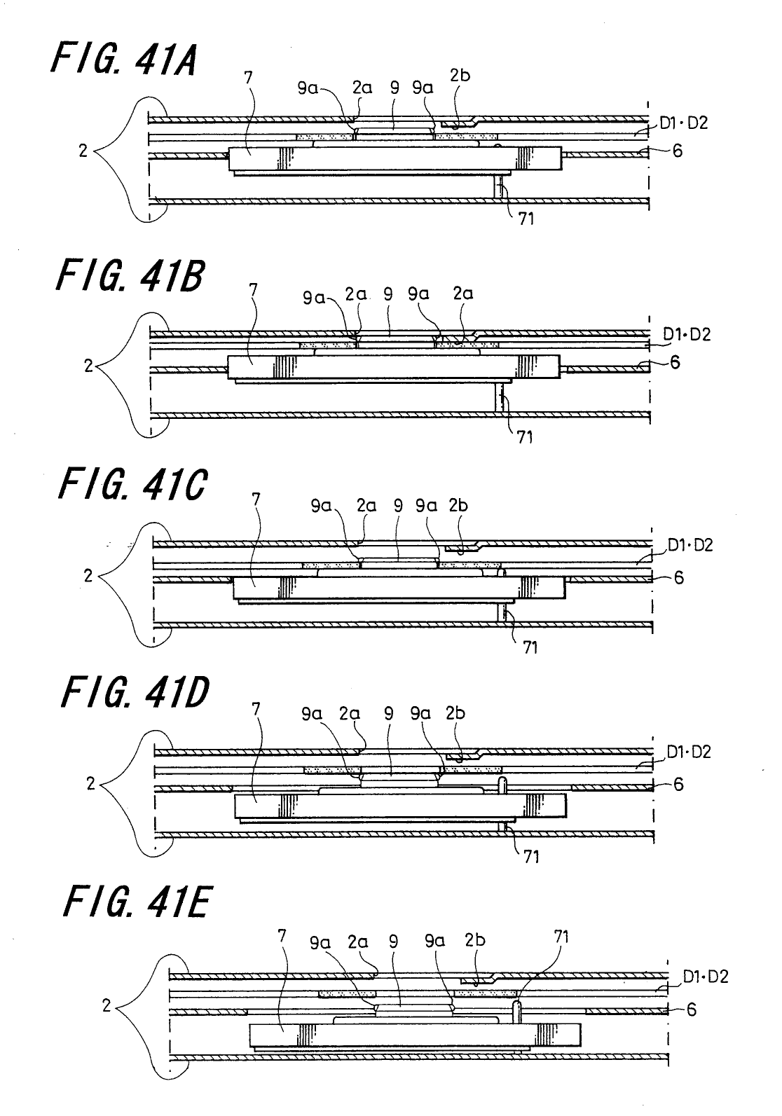

Similarly, the disc supporting arm 19, the guide arm 29, the guide arm 35 and the loading arm 22 to which power is transmitted as the loading slider 43 is slid also are placed in the static state in the states shown in FIG. 12. Also, the follower pin 7a of the elevation frame 7 guided by the cam groove 43e of the loading slider 43 is placed at the low position portion 43e-1 of this cam groove 43. On the other hand, the follower pin 7b of the elevation frame 7 guided by the cam groove 48c of the follower slider 48 is placed at the low position portion 48c-1 of this cam groove 48c so that the elevation frame 7 is lowered most as shown in FIG. 40A.

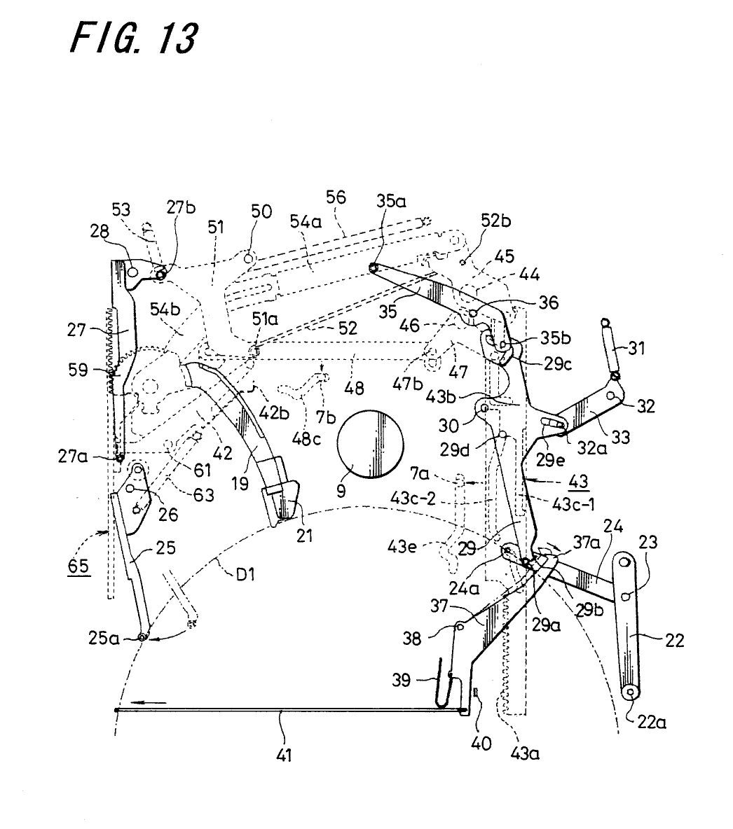

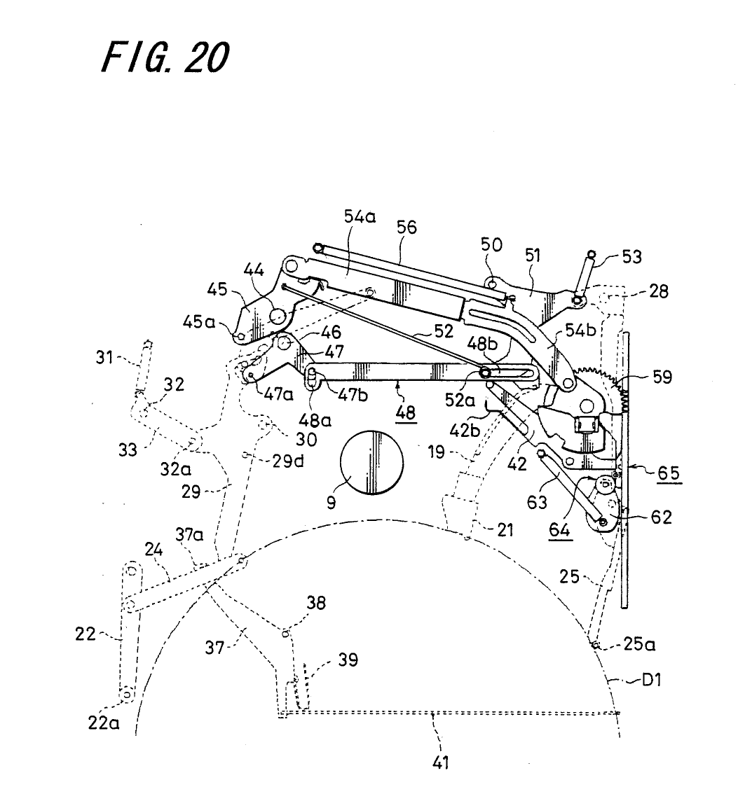

FIGS. 13 and 20 show states in which the large-diameter disc D1 is inserted into the disc apparatus 1 from the slot 3a of the front bezel 3 by an operator so that the front end side of this large-diameter disc D1 is brought in contact with the holder 21 of the disc supporting arm 19 and the supporting member 29a of the guide arm 29. At that time, the large-diameter disc D1 presses the supporting member 25a provided at the tip end of the guide arm 25 and hence the guide arm 25 is swung to the centrifugal direction from the position shown by an imaginary line in FIG. 13. At that time, the side portion of the large-diameter disc D1 presses the engagement end portion 41a of the lead wire 41 and the lead wire 41 is slid in the direction shown by an arrow in FIG. 13. As a consequence, the lock lever 37 is pulled by the lead wire 41 and the angle 37a provided at the tip end of the lock lever 37 is swung in the direction shown by an arrow in FIG. 13 so that the lock lever 37 is released from a range to lock the strip piece 29b formed at the tip end of the guide arm 29.

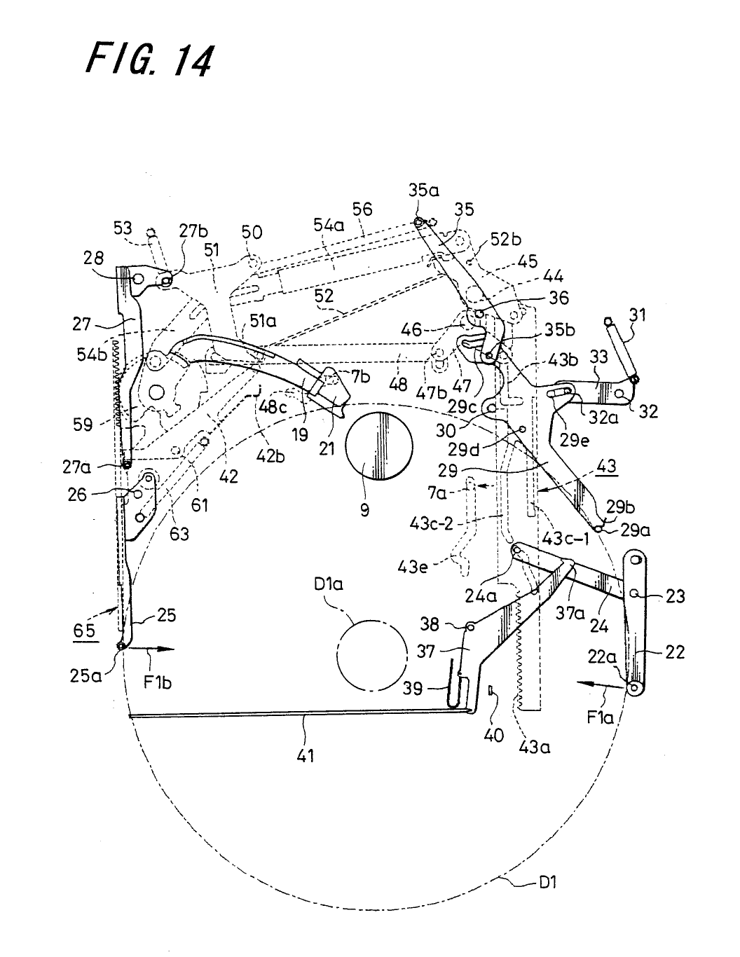

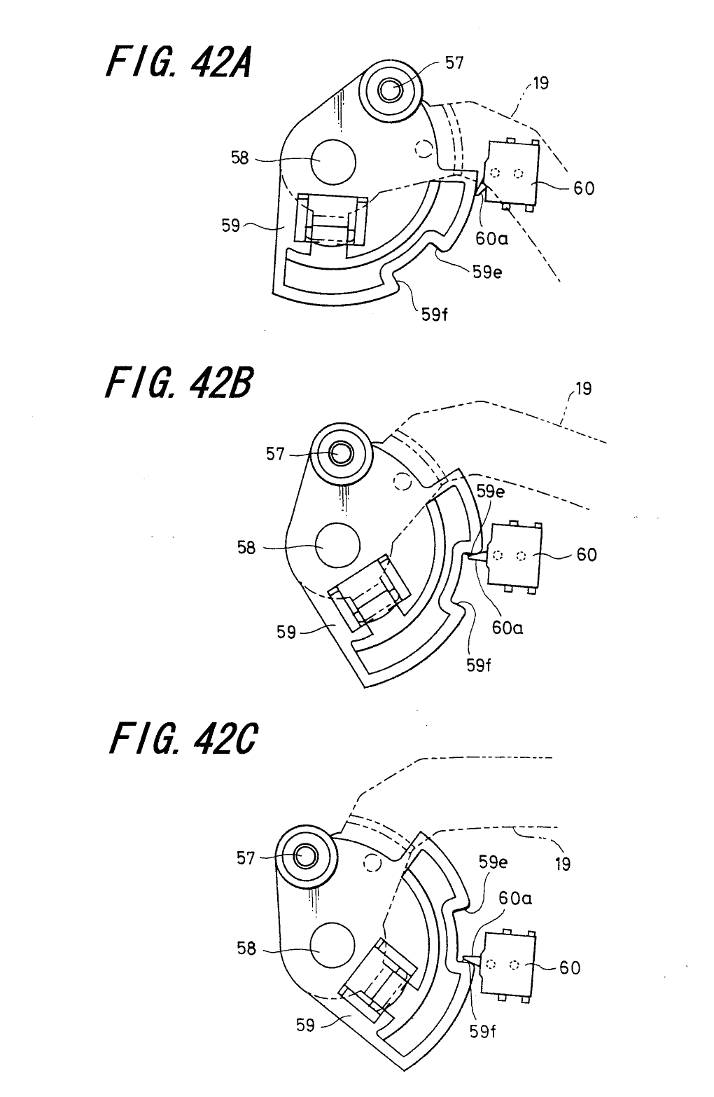

FIGS. 14 and 21 show states in which the large-diameter disc D1 is further inserted from the above-described state by the operator. When pressed by the large-diameter disc D1, the disc supporting arm 19, the guide arm 25 and the guide arm 29 are swung in the centrifugal direction. Accordingly, the base portion of the disc supporting arm 19 is rotated at the rivet pin 20 from the position shown in FIG. 42A to the position shown in FIG. 42B, whereby the limit switch 60 is energized by the switch actuating stepped portion 59e of the gear disc 59. It should be noted that the rack slider 65 meshed with the gear disc 59 is slightly moved forward.

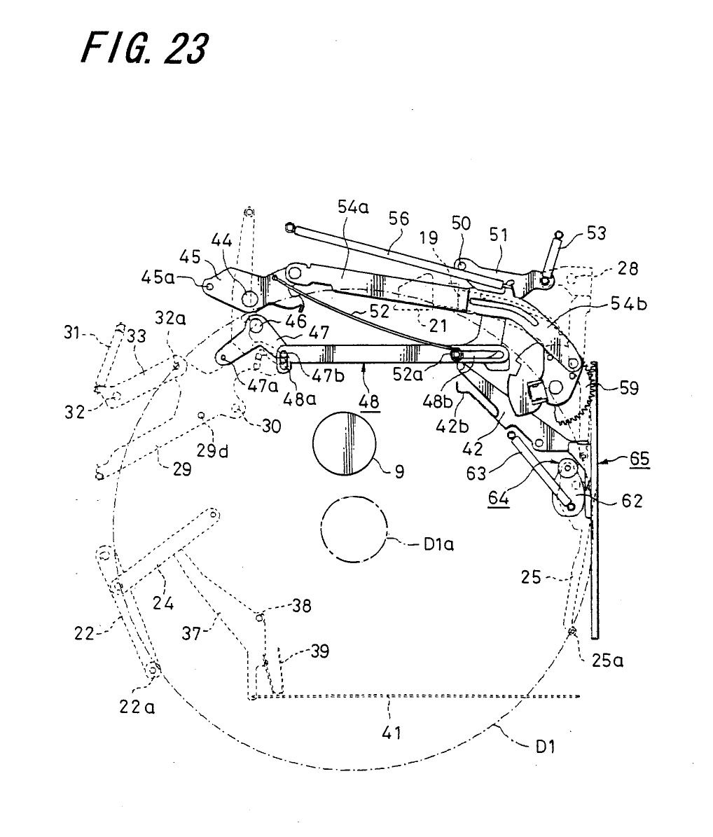

Based on a signal generated from the limit switch 60 energized by the above-described switch actuating stepped portion 59e, at this time, a current of a low potential voltage flows through the loading motor 66. In consequence, the loading slider 41 is moved backward to pull the link lever 24 so that the loading arm 22 is swung up to the position shown by an imaginary line shown in FIG. 23. As a result, the loading roller 22a provided at the tip end of the loading arm 22 is brought in contact with the large-diameter disc D1 and stopped.

Herein, potential of a current of the above-described low potential is set based on potential necessary for transporting the small-diameter disc D2 which will be described later on. At this time point, when a current of high potential to generate a torque large enough to transport the large-diameter disc D1 flows, there is a risk that defects will occur in the transporting mechanism. More specifically, in FIG. 14, since a component of a force F1a generated by pressing of the loading arm 22 and a component of a force F1b generated by pressing of the supporting arm 25a of the guide arm 25 are existing substantially near the center of the large-diameter disc D1, its resultant force is extremely small so that propulsive force to move the large-diameter disc D1 in the transporting direction is not generated. In addition, in the state shown in FIG. 14, the supporting member 29a provided at the tip end of the guide arm 29 and which is spring-biased in the centripetal direction is pushing the rear side portion of the large-diameter disc D1.

In such situation, when a current of high potential necessary for transporting the large-diameter disc D1 is supplied to the loading motor 66, the loading arm 22 is stopped while it is holding the large-diameter disc D1 and the transporting operation is stopped. If this condition is continued, then there is a risk that the gear train of the transporting mechanism will be broken or that the loading motor 66 will be burned and broken. In order to avoid the above-mentioned disadvantages, at this time point, a current of low potential necessary for transporting the small-diameter disc D2 is supplied to the loading motor 66.

It should be noted that, in the state in which the current of low potential is supplied to the loading motor 66, since the large-diameter disc D1 becomes a load so that the loading arm 22 may not be rotated by only driving force of the loading motor 66, the transporting operation of the large-diameter disc D1 is not carried out. Thus, when the operator presses the large-diameter disc D1, the driving force of the loading motor 66 and insertion force given by the operator are applied to the loading arm 22 so that the transporting operation of the large-diameter disc D1 can be carried out.

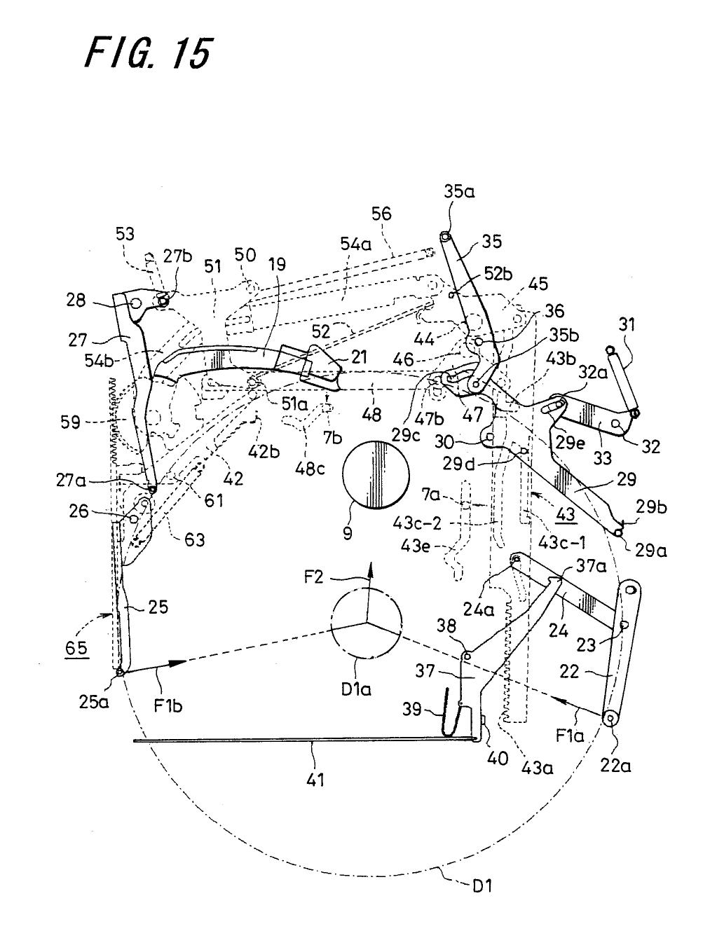

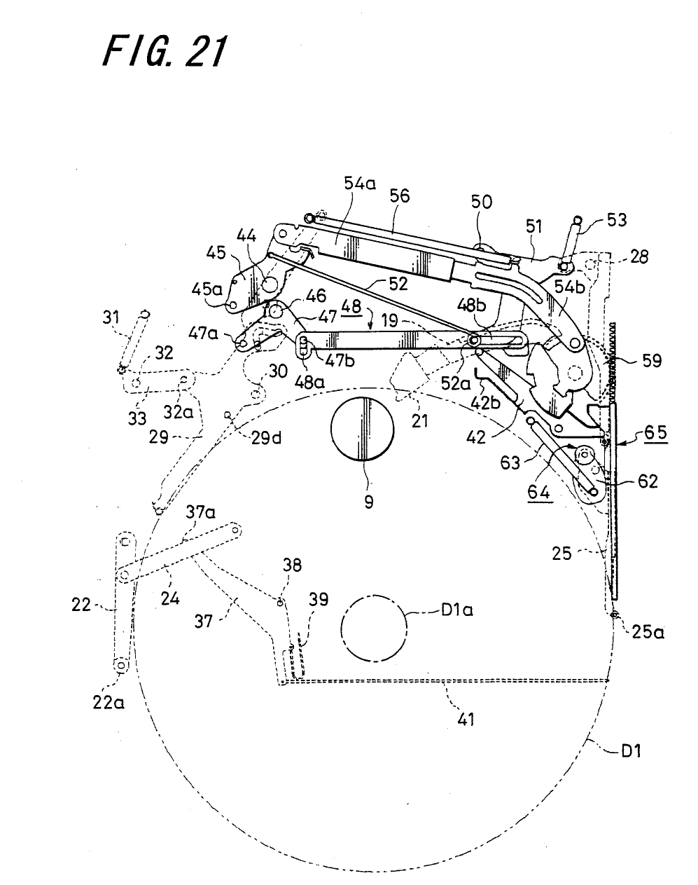

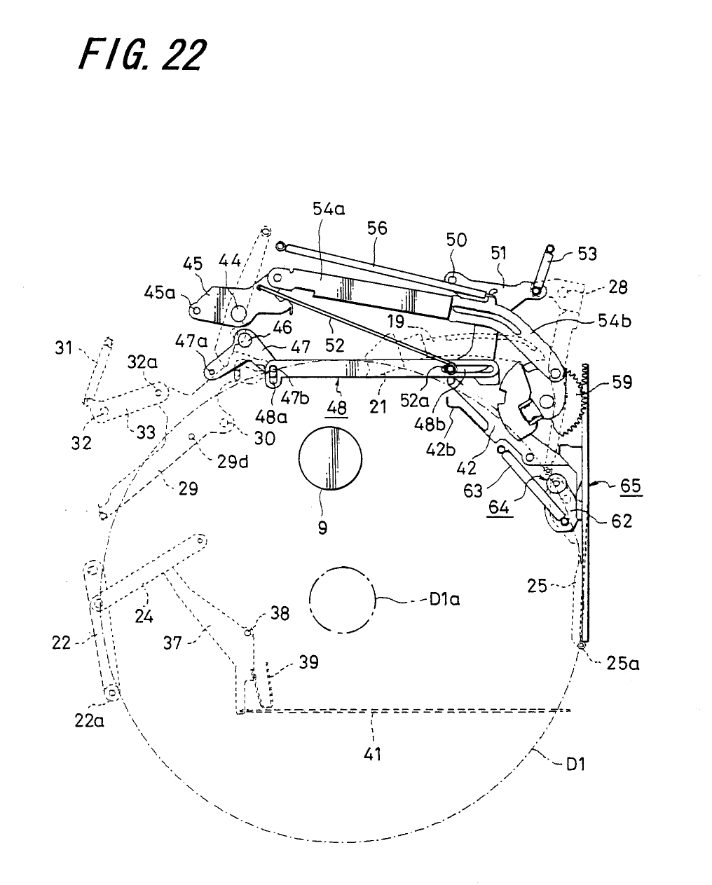

FIGS. 15 and 22 show states in which the large-diameter disc D1 was further inserted by the operator from the above-described state and in which the gear disc 59 provided at the base portion of the disc supporting arm 19 is further rotated. As a result, since the link arm 54 is pulled and the first swing member 45 is swung at the rivet pin 44 to cause the follower pin 45a to be moved in the backward, the loading slider 43 spring-biased by the driving force of the loading motor 66 through which a current of low potential is flowing also is moved in the backward direction.

In such operation, the guide arm 29 is swung in the centrifugal direction to release the large-diameter disc D1 from being supported by the supporting member 29a. This is because the follower pin 29d of the guide arm 29 located on the inclined surface of the rear end portion of the guide groove 43c-1 of the loading slider 43 is affected by the action of the inclined surface as the loading slider 43 is moved backward.

As the first swing member 45 is swung as described above, the third swing member 51 of which swinging is restricted by the link wire 52 may be swung at the rivet pin 50 due to the action of the tension coil spring 53. Consequently, the guide arm 27 may swing in the centripetal direction to allow the supporting member 27a provided at the tip end of the guide arm 27 to support the rear side portion of the large-diameter disc D1. At that time, since the loading slider 43 is moved in the backward direction to pull the link lever 24, the loading arm 22 is swung in the centripetal direction and the loading roller 22a provided at the tip end of the loading arm 22 contacts with the front side portion of the large-diameter disc D1 to support the large-diameter disc D1. It should be noted that, since the follower pin 7a of the elevation frame 7 is placed in the state in which it is moved horizontally in the low position portion 43e-1 of the cam groove 43e, this elevation frame 7 remains at the position shown in FIG. 40A.

On the other hand, the gear disc 59 at the base portion of the disc supporting arm 19 is rotated up to the position shown in FIG. 42C and the switch actuating stepped portion 59f inverts the switch knob 60a of the limit switch 60. A torque necessary for transporting the large-diameter disc D1 is generated by switching the current supplied to the loading motor 66 to the high potential based on a signal generated from the limit switch 60 at this time. Then, since the component of a force F1a generated by pressing of the loading roller 22a and the component of a force F1b generated by pressing of the supporting member 25a of the guide arm 25 are increased, resultant force F2 which pushes the large-diameter disc D1 in the transporting direction is generated and automatic loading of the large-diameter disc D1 by the loading motor 66 is started.

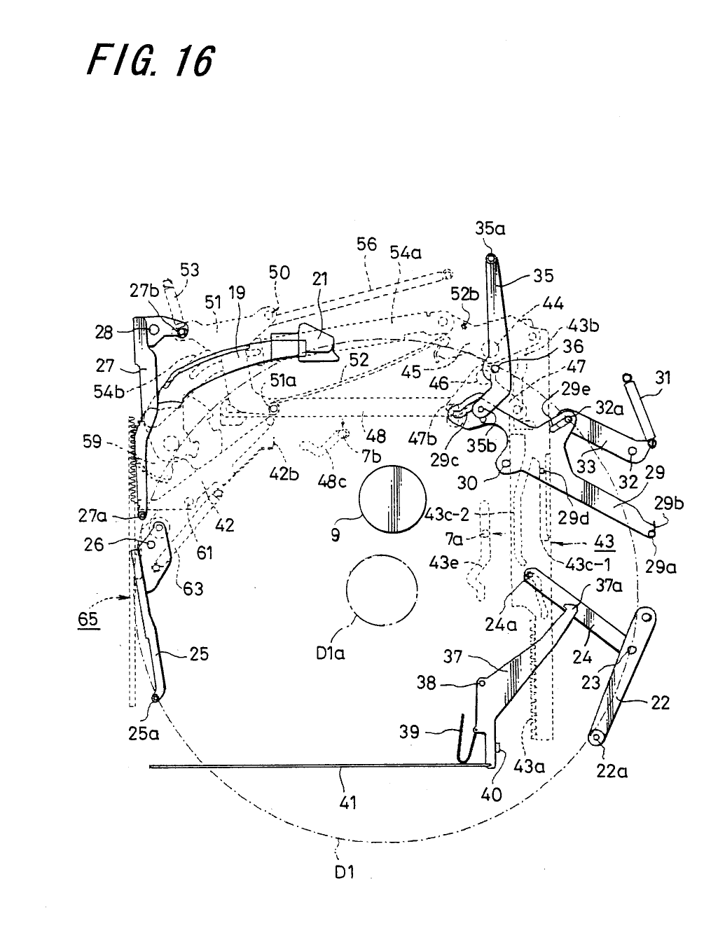

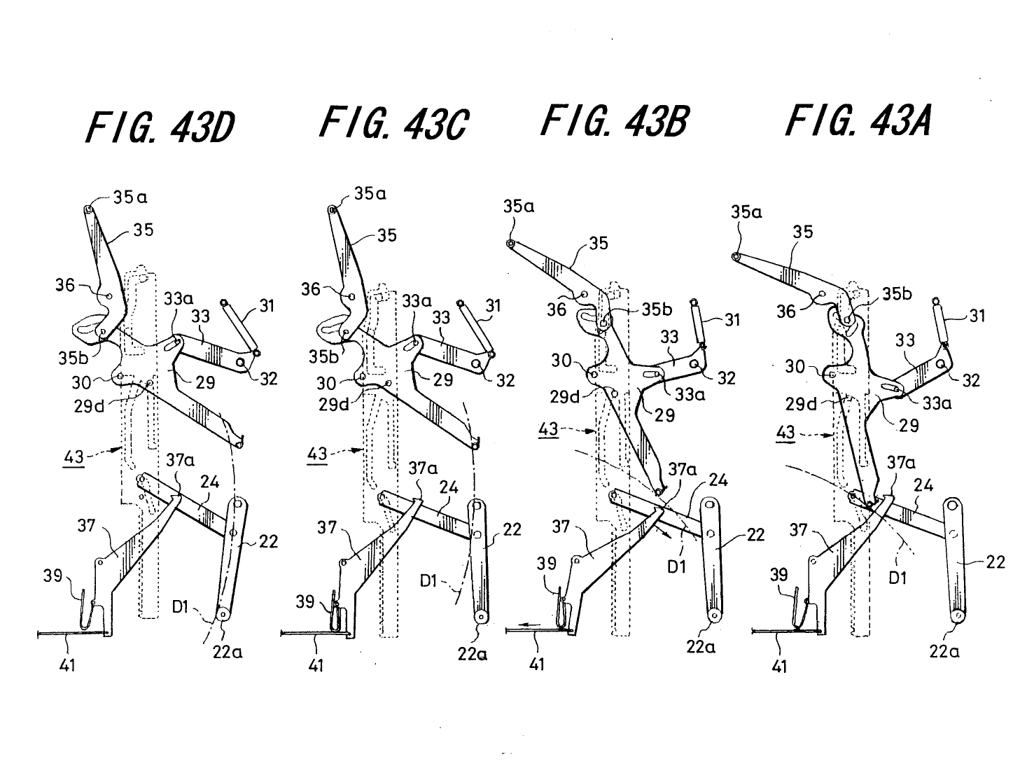

FIGS. 16 and 23 show states in which automatic loading of the large-diameter disc D1 by the loading motor 66 is started and in which the large-diameter disc D1 is being transported. When the loading slider 43 is further moved backward from the state shown in FIG. 15, the follower pin 29d of the guide arm 29 is entered from the inclined portion of the loading slider 43 into the guide groove 43c-1. As a consequence, the guide arm 29 is further swung in the centrifugal direction, whereby the supporting member 29a provided at the tip end of the guide arm 29 is placed in the state in which it may not contact with the side portion of the large-diameter disc D1. It should be noted that FIGS. 43A to 43D show operation modes of the guide arm 29 continuously.

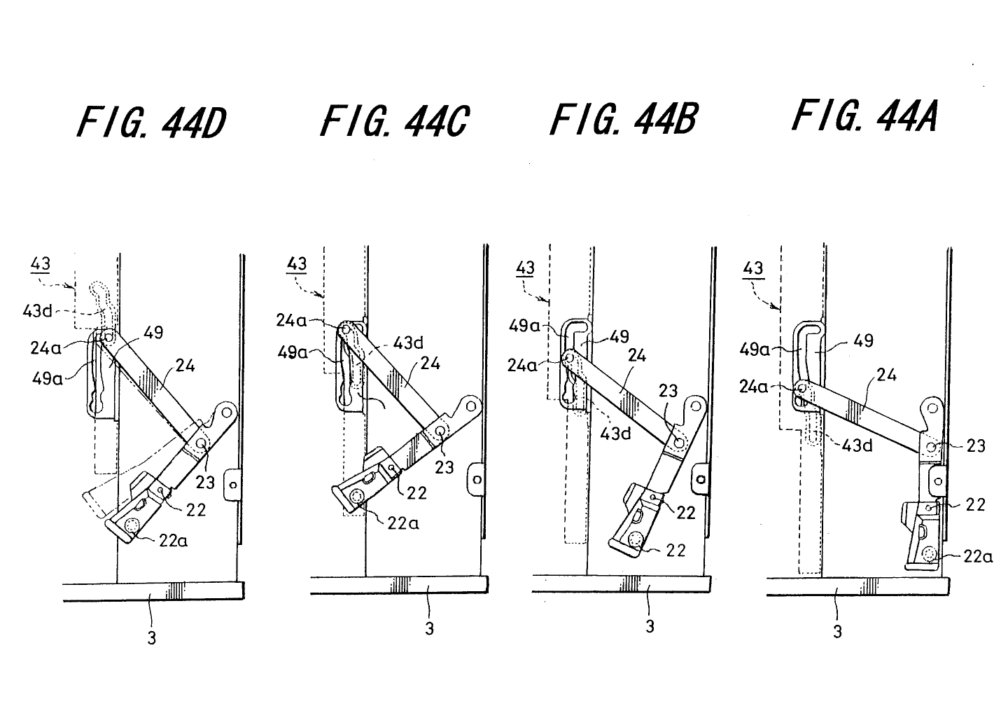

Also, when the loading slider 43 is moved in the backward direction, the link lever 24 is pulled to start swinging the loading arm 22 in the centripetal direction. FIGS. 44A to 44D show the swinging states of the loading arm 22 continuously. The state of the loading arm 22 shown in FIG. 15 corresponds to the state in which the loading arm 22 is moved from the initial state shown in FIG. 44A to the state shown in FIG. 44B.

In the link lever 24 which may administer swinging of the above-described loading arm 2, since the follower pin 24a secured to the tip end of the link lever 24 is fitted into the guiding groove 43d of the loading slider 43 and the guide slit 49a of the guide plate 49, when the loading slider 43 is moved in the backward direction, the follower pin 24a is sandwiched between the inclined surface of the rear end of the guiding groove 43d and the side wall of the guide slit 49a. Therefore, as the loading slider 43 is moved in the backward direction, the follower pin 24a also is moved in the backward direction to pull the link lever 24 so that the loading arm 22 may be swung.

When the loading slider 43 is moved backward to the position shown in FIG. 16, concurrently therewith, the upper end horizontal portion 43b-1 of the guide groove 43b elevates the follower pin 45a of the first swing member 45 so that the first swing member 45 may swing at the rivet pin 44 to rotate the gear disc 59 through the link arm 54. As a result, the disc supporting arm 19 is swung to the centrifugal direction, that is, the holder 21 which supports the rear end portion of the large-diameter disc D1 is moved in the backward direction in synchronism with the transporting of the large-diameter disc D1. It should be noted that, at this time point, since the follower pin 47a of the second swing member 47 slides the vertical portion of the guide groove 43b, the second swing member 47 is placed in the static state and the follower slider 48 also is placed in the static state.

In the process in which the state is moved from FIGS. 15 to 16, in the guide arm 27 spring-biased under spring force of the tension coil spring 53, the supporting member 27a provided at the tip end of the guide arm 27 is returned in accordance with the transport of the large-diameter disc D1 and it is brought in contact with the locking strip piece 42a of the lever arm 42, thereby being stopped. At that time, since the third swing member 51 is swung slightly, its action pin 51a is moved within the end portion through-hole 48b of the follower slider 48, which is placed in the static state, in the centripetal direction and therefore the link wire 52 is flexed slightly.

On the other hand, the supporting member 25a of the guide arm 25 supports the front side portion of the large-diameter disc D1 and the high position guide piece 65c of the rack slider 65 moved forward by rotation of the above-described gear disc 59 is spaced apart from the small-diameter portion 64v of the double roller 64. It should be noted that, at that time, since the follower pin 7a of the elevation frame 7 is placed in the state in which it is moved horizontally in the low position portion 43e-1 of the cam groove 43e and the follower slider 48 is placed in the static state, the elevation frame 7 is suddenly stopped at the position shown in FIG. 40A.

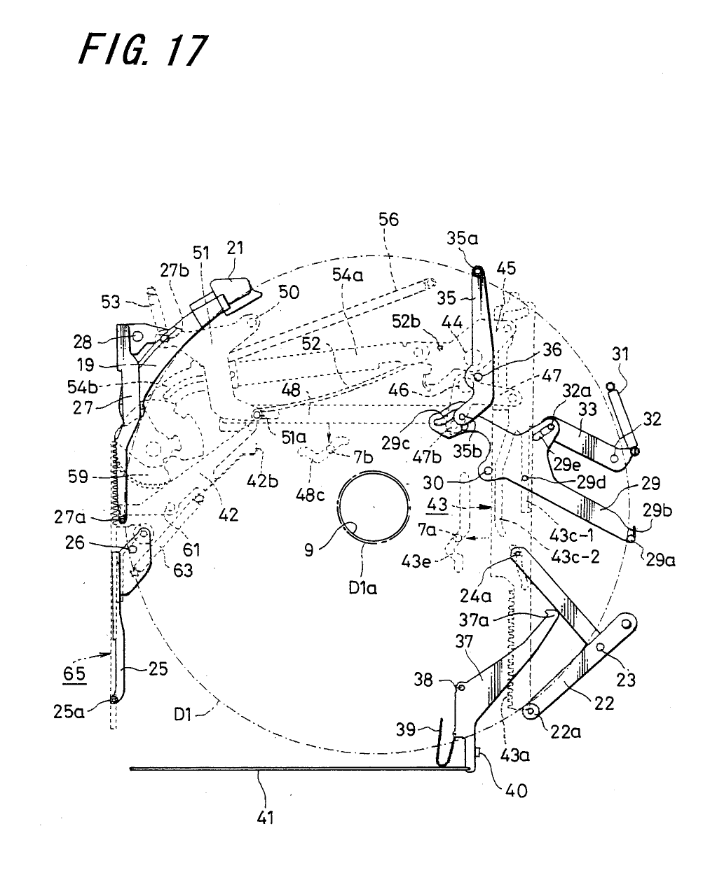

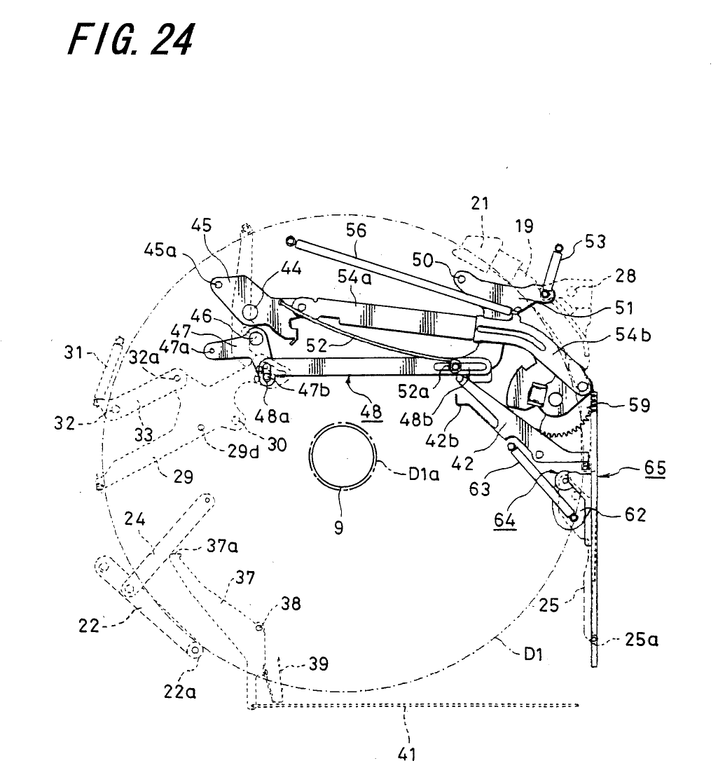

FIGS. 17 and 24 show states in which the loading slider 43 is further moved backward from the states shown in FIGS. 16 and 23 to pull the link lever 24 so that the loading arm 22 is swung up to the position shown in FIG. 44C, thereby resulting in the central hole D1a of the transported large-diameter disc D1 and the center of the clamping head 9 being made coincident with each other. On the other hand, since the follower pin 29d of the guide arm 29 becomes able to move linearly through the guide groove 43c-1 of the loading slider 43, the guide arms 29 and 35 are placed in the static state at the positions shown in FIG. 17. At that time, the supporting members 29a and 35a receive the outer peripheral edge of the large-diameter disc D1 to thereby properly position the large-diameter disc D1 so that the central hole D1a of the large-diameter disc D1 and the position of the clamping head 9 can agree with each other accurately.

Since the follower pin 45a of the first swing member 45 is urged against the upper end horizontal portion 43b-1 and moved to the vertical portion 43b-3 as the loading slider 43 is moved backward, this first swing member 45 is swung up to the position shown in FIG. 17 and the disc supporting arm 19 also is swung in the centrifugal direction as the gear disc 59 is rotated by the link arm 54. When the above-described gear disc 59 is rotated, since the rack slider 65 is further moved forward so that the small-diameter portion 64b of the double roller 64 is urged against the high position guide piece 65c, the guide arm 25 is considerably swung in the centrifugal direction and the operation to support the outer peripheral edge of the large-diameter disc D1 by the supporting member 25a is ended. As a consequence, the guide arm 25 is escaped to the lateral side of the elevation frame 7 and it is not extended over the elevation frame 7. Therefore, there is no risk that the ascending elevation frame 7 and the guide arm 25 will collide with each other.

At that time, although the large-diameter disc D1 presses the supporting member 27a of the guide arm 27, this supporting member 27a is brought in contact with the locking strip piece 42a of the lever arm 42 and its stopped position is determined. Therefore, at this time point, the center of the large-diameter disc D1 may coincide with the clamping head 9 in the horizontal direction. On the other hand, the center of the large-diameter disc D1 relative to the clamping head 9 in the vertical direction is determined by the holder 21 of the disc supporting arm 19 and the loading roller 22a of the loading arm 22 which were placed in the static state in the state shown in FIG. 17.

As described above, according to the disc apparatus of the present invention, until the state reaches the state shown in FIG. 17 since the automatic loading of the large-diameter disc D1 was started, at least three portions of the outer peripheral edge of this large-diameter disc D1 are supported by a plurality of aforementioned arms and the large-diameter disc D1 is transported into the disc apparatus 1 in which it is placed in the static state at the position in which the central hole D1a of the large-diameter disc 1 can be clamped by the clamping head 9.

Also, in the process from FIGS. 16 to 17, the cam groove 43e of the loading slider 43 is moved backward, whereby the follower pin 7a of the elevation frame 7 is moved from the low position portion 43e-1 to the inclined portion 43e-2 and it is placed in the state in which it will ascend. On the other hand, since the follower pin 47a of the second swing member 47 reaches from the vertical portion 43b-3 of the loading slider 43 to the lower end horizontal portion 43b-2 and this second swing member 47 is swung in the centrifugal direction, the cam groove 48c is moved in the horizontal direction as the follower slider 48 is moved in the horizontal direction by the action pin 47b. As a result, the follower pin 7b of the elevation frame 7 is moved from the low position portion 48c-1 to the inclined portion 48c-2 and it is placed in the state in which it will ascend and the elevation frame 7 starts ascending as shown in FIG. 40B.

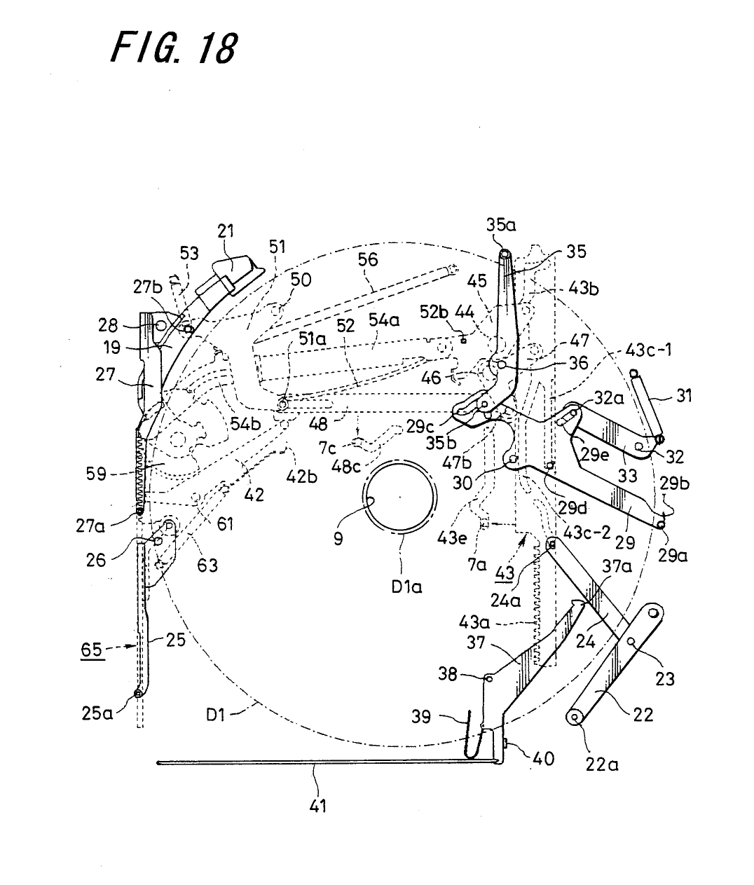

FIGS. 18 an 25 show states in which the clamping head 9 clamps the central hole D1a of the large-diameter disc D1 so that the operation mode reaches the final state in which it becomes possible to drive the large-diameter disc D1. To reach this final state, the disc supporting arm 19, the loading arm 22 and the guide arm 27 which support the large-diameter disc D1 should be swung slightly in the centrifugal direction and end supporting the large-diameter disc D1 so as not to disturb rotation of the large-diameter disc D1.

More specifically, at the position in which the loading slider 43 is further moved backward and stopped from the state shown in FIG. 17, since the follower pin 24a of the link lever 24 is fitted into the lateral groove of the rear end of the guide slit 49a at an eccentricity portion of the rear portion of the guiding groove 43d in the vertical direction, as shown in FIG. 44D, the link lever 24 is slightly returned to the direction opposite to the pulled direction and the loading arm 22 is slightly swung in the centrifugal direction. Then, the operation to support the outer peripheral edge of the large-diameter disc D1 by this loading roller 22a is ended.

Also, at the same time, the follower pin 45a of the first swing member 45 is slightly swung by the inclined portion formed in the middle position of the vertical portion 43b-3 of the guide groove 43b so that this swinging is transmitted through the link arm 54 to the gear disc 59. As a result, the disc supporting arm 19 is slightly swung in the centrifugal direction and the operation to support the outer peripheral edge of the large-diameter disc D1 by this disc supporting arm 19 is ended.

On the other hand, the lower end horizontal portion 43b-2 of the guide groove 43b of the loading slider 43 considerably elevates the follower pin 47a of the second swing member 47. Consequently, the action pin 47b is swung in the centrifugal direction to horizontally move the follower slider 48 so that the end through-hole 48b pulls the action pin 51a of the third swing member 51. Thus, this third swing member 51 is slightly swung and at the same time, the action piece 48d elevates the roller 42c of the lever arm 42. As a result, the locking strip piece 42a of the lever arm 42 with which the supporting member 27a of the guide arm 27 contacts is moved in the backward direction so that the guide arm 27 is slightly swung in the centrifugal direction. Then, the operation to support the outer peripheral edge of the large-diameter disc D1 by this guide arm 27 is ended.

At that time, the end portion of the guide groove 43c-1 of the loading slider 43 presses the follower pin 29d of the guide arm 29 to slightly swing the guide arm 29. As a result, the supporting member 29a of the guide arm 29 is swung in the centrifugal direction and the operation to properly position the outer peripheral edge of the large-diameter disc D1 is ended. Also, since the guide arm 35 joined to the guide groove 29c of the guide arm 29 by the follower pin 35b is swung slightly, the supporting member 35a also is swung in the centrifugal direction and the operation to properly position the outer peripheral edge of the large-diameter disc D1 is ended.

It should be noted that, in the process in which the operation mode moved from FIGS. 17 to 18, although the follower slider 48 is moved horizontally in synchronism with the backward movement of the loading slider 43, the follower pin 7a of the elevation frame 7 is moved from the inclined portion 43e-2 of the cam groove 43e of the loading slider 43 to the high position portion 43e-3 and the follower pin 7b is moved from the inclined portion 48c-2 to the high position portion 48c-3 in the cam groove 48c of the follower slider 48.

In the behavior of the elevation frame 7 in this process, the elevation frame 7 is ascended by the follower pins 7a and 7b which are elevated by the inclined portions 48e-2 and 48c-2 and as shown in FIG. 40C, the chuck claw 9a of the clamping head 9 contacts with the central hole D1a of the large-diameter disc D1 to elevate this large-diameter disc D1, thereby resulting in the peripheral edge of the central hole D1a being brought in contact with the protruded portion 2b of the chassis case 2.

When the follower pins 7a and 7b reach the tops of the inclined portions 43e-2 and 48c-2 from the above-described state, as shown in FIG. 40D, the clamping head 9 is fitted into the central hole D1a of the large-diameter disc D1 and clamping of the large-diameter disc D1 by the chucking claw 9a is completed, whereby the large-diameter disc D1 is fixed to the turntable 10. Then, the follower pins 7a and 7b are moved to the high position portions 43e-3 and 48-3 and the elevation frame 7 is lowered to the position shown in FIG. 40E, thereby making it possible to drive the large-diameter disc D1.

While the modes in which the respective mechanisms are operated when the large-diameter disc D1 is loaded into the disc apparatus 1 according to the present invention have been described so far, when the large-diameter disc D1 is unloaded from the disc apparatus 1, the respective mechanisms are operated in the opposite orders as the loading slider 43 is moved forward. Specifically, when unloading of the large-diameter disc D1 is started and the loading slider 43 starts advancing, the elevation frame 7 is temporarily ascended and then descended to the initial position as shown in FIGS. 41A to 41E. During this period, the large-diameter disc D1 is pushed by the clamp releasing pin 71 as shown in FIG. 41C and the large-diameter disc D1 is released from being clamped by the clamping head 9.

In the process executed until clamping of the large-diameter disc D1 is released as described above, the disc supporting arm 19, the loading arm 22 and the guide arm 27 start moving in the centripetal direction and the operation mode becomes the state in which the outer peripheral edge of the large-diameter disc D1 is supported as shown in FIG. 17. After that, the large-diameter disc D1 is unloaded from the disc apparatus 1 by force to swing the disc supporting arm 19 in the centripetal direction, its front end portion is exposed to the outside from the slot 3a of the front bezel 3 and then the disc apparatus 1 is stopped.

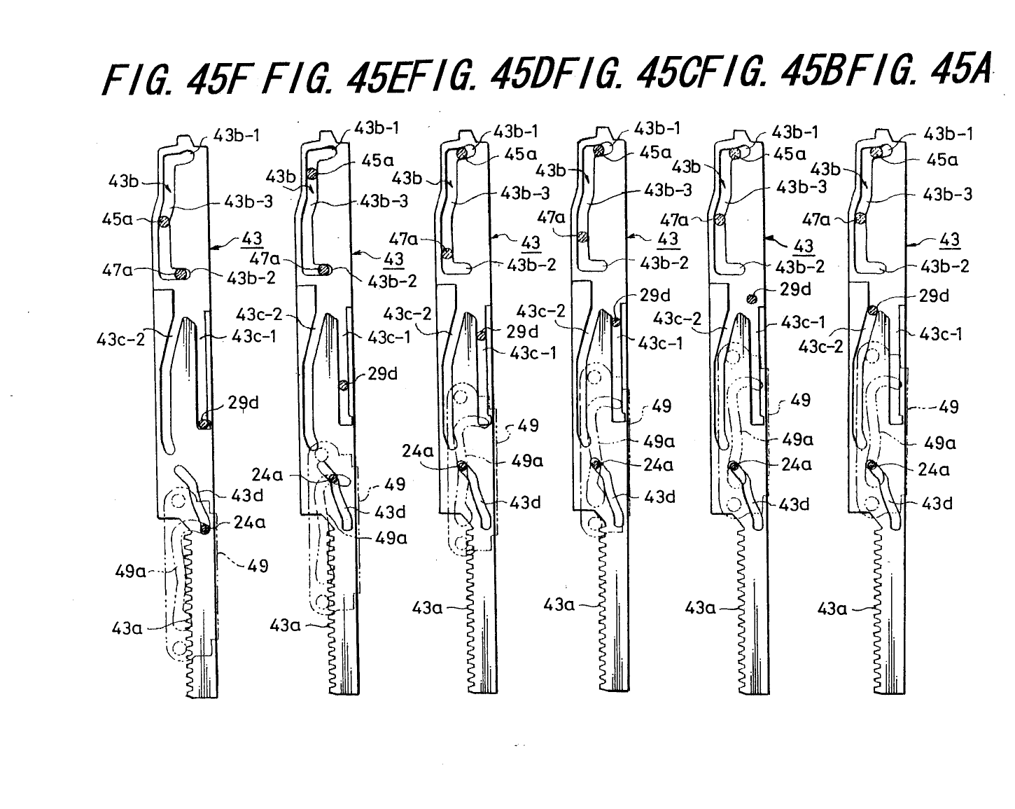

It should be noted that operation modes in which the follower pins 24a, 29d, 45a and 47a are operated as the loading slider 43 is moved backward will be described with reference to FIGS. 45A to 45F.

Operation modes in which the small-diameter disc D2 is transported by the disc apparatus according to the present invention will be described with reference to plan views of FIGS. 26 to 32 and corresponding bottom views of FIGS. 33 to 39. It should be noted that, while the cam grooves 43e, 48c and the follower pins 7a, 7b are inherently not shown in FIGS. 26 to 32, they are shown in FIGS. 26 to 32 in order to facilitate understanding of the present invention.

FIGS. 26 and 33 are diagrams showing states in which the disc apparatus 1 is placed in the standby state to await insertion of the small-diameter disc D2 from the slot 3a of the front bezel 3 and in which respective arms are placed in the static state in the initial state. At that time, in the guide arm 25, the large-diameter portion 64a of the double roller 64 of the roller supporting plate 62 fixed to the above-described pivot pin 26 at the back surface of the base panel 6 is brought in contact with the low position guide piece 65b of the rack slider 65 as shown in FIGS. 11 and 33 and the guide arm 25 is stopped at the position swung by a predetermined amount in the centrifugal direction from the position at which it is swung most in the centripetal direction.

If the disc apparatus 1 is configured such that the guide arm 25 is stopped at the position in which it is swung most in the centripetal direction to await insertion of the disc, when the small-diameter disc D2 is displaced to the left-hand side of the disc apparatus 1 and inserted into the disc apparatus 1, the small-diameter disc D2 is inserted into the left-hand side of the supporting member 25a so that it becomes impossible to transport the small-diameter disc D2. In order to avoid this risk, the guide arm 25 is stopped at the position in which it is swung by a predetermined amount in the centrifugal direction from the position at which it is swung most in the centripetal direction and the disc apparatus 1 awaits insertion of the disc. It should be noted that the states in which the disc apparatus 1 awaits the small-diameter disc D2 as shown in FIGS. 26 and 33 may agree with the states in which the disc apparatus 1 awaits insertion of the large-diameter disc D1 as shown in FIGS. 12 and 19.

Next, since the guide arm 27 is spring-biased at its base end portion under spring force of the tension coil spring 53, although the supporting member 27a provided at the tip end of the guide arm 27 is constantly spring-biased so as to swing in the centripetal direction, the third swing member 51 joined to the pivot pin 27b is placed in the static state at a predetermined position and this guide arm 27 is placed in the static state in the state shown in FIG. 26. The reason for this is that the lead wire 52 attached between the first swing member 45 in the static state and the action pin 51a of the third swing member 51 can function as a stopper to thereby prevent the third swing member 51 from being swung.

Similarly, the disc supporting arm 19, the guide arm 29, the guide arm 35 and the loading arm 22 to which power is transmitted as the loading slider 43 is moved also are placed in the static state in the state shown in FIG. 26. Also, while the follower pin 7a of the elevation frame 7 guided by the cam grove 43e of the loading slider 43 is placed at the low position portion 43e-1 of this cam groove 43e. On the other hand, the follower pin 7b of the elevation frame 7 guided by the cam groove 48c of the follower slider 48 is placed at the low position portion 48c-1 so that the elevation frame 7 is placed in the state in which it is lowered most as shown in FIG. 40A.

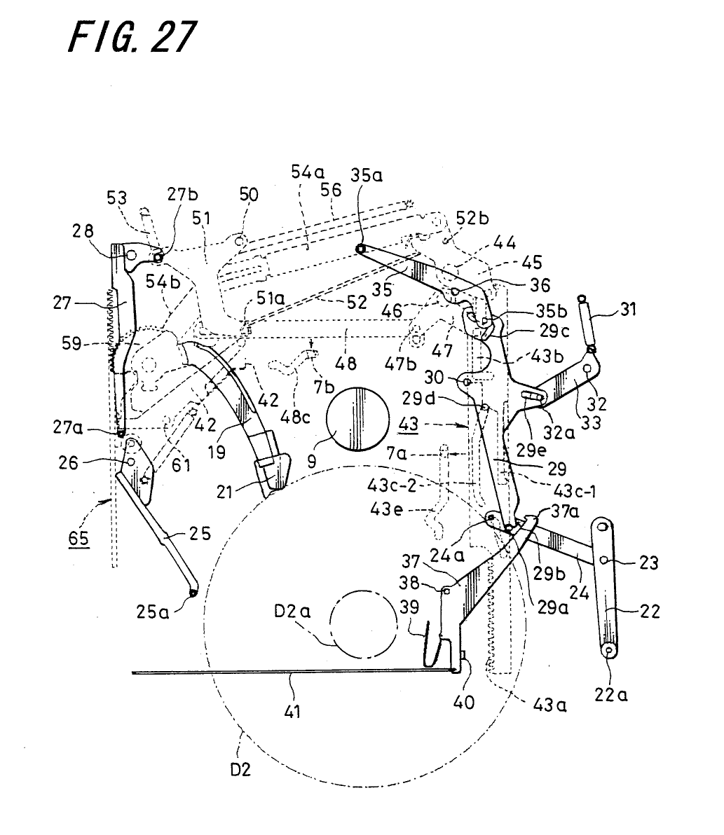

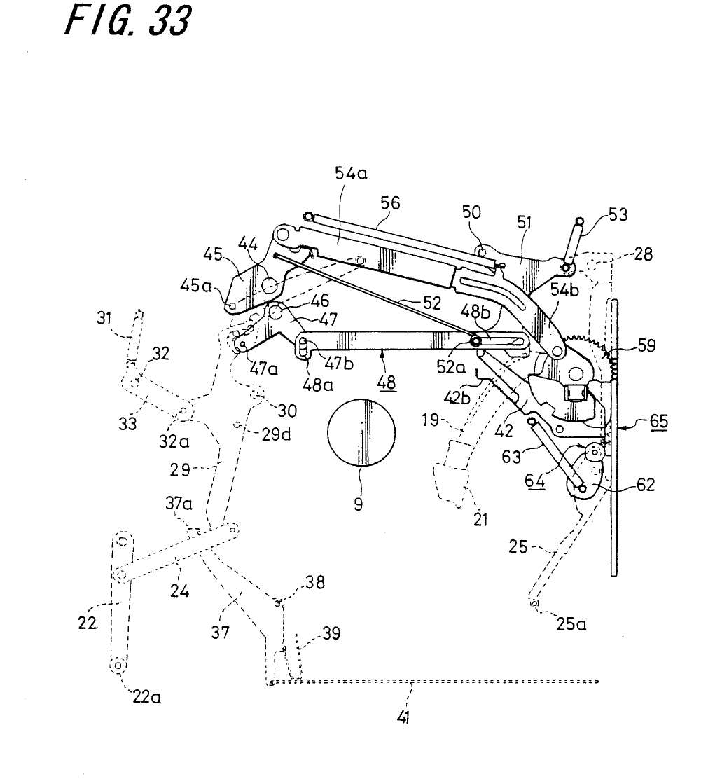

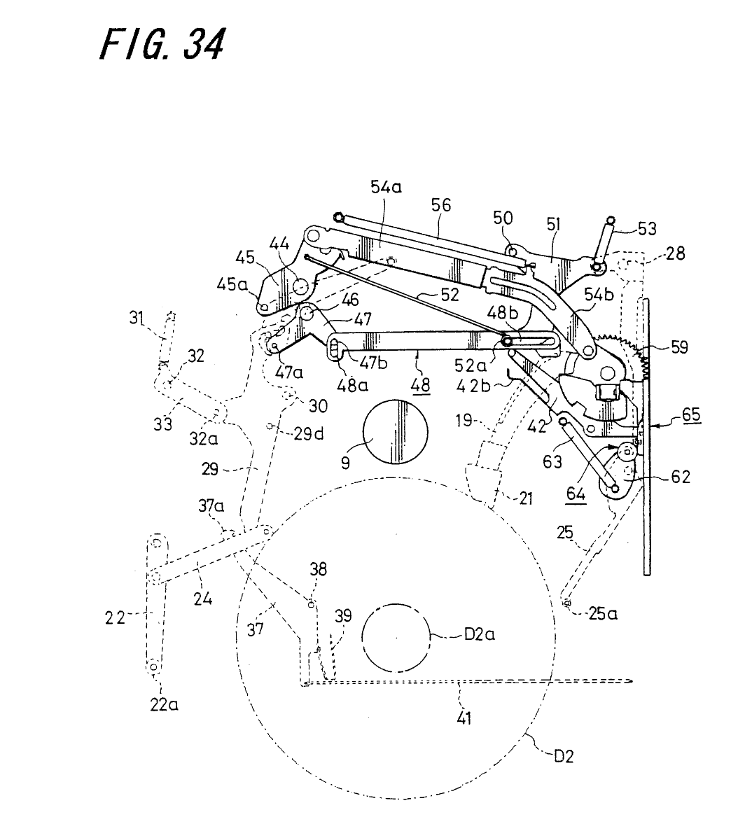

FIGS. 27 and 34 show states in which the small-diameter disc D2 is inserted into the disc apparatus 1 from the slot 3a of the front bezel 3 by the operator and in which the front end side of the small-diameter disc D2 is brought in contact with the holder 21 of the disc supporting arm 19. When this small-diameter disc D2 is inserted into the slot 3a, if the small-diameter disc D2 is displaced to the left-hand side in FIG. 27, then the left side portion of the front end of the small-diameter disc D2 is brought in contact with the supporting member 25a of the guide arm 25 and pushed back. Therefore, it is possible to prevent the small-diameter disc D2 from being dropped out of the transport path.

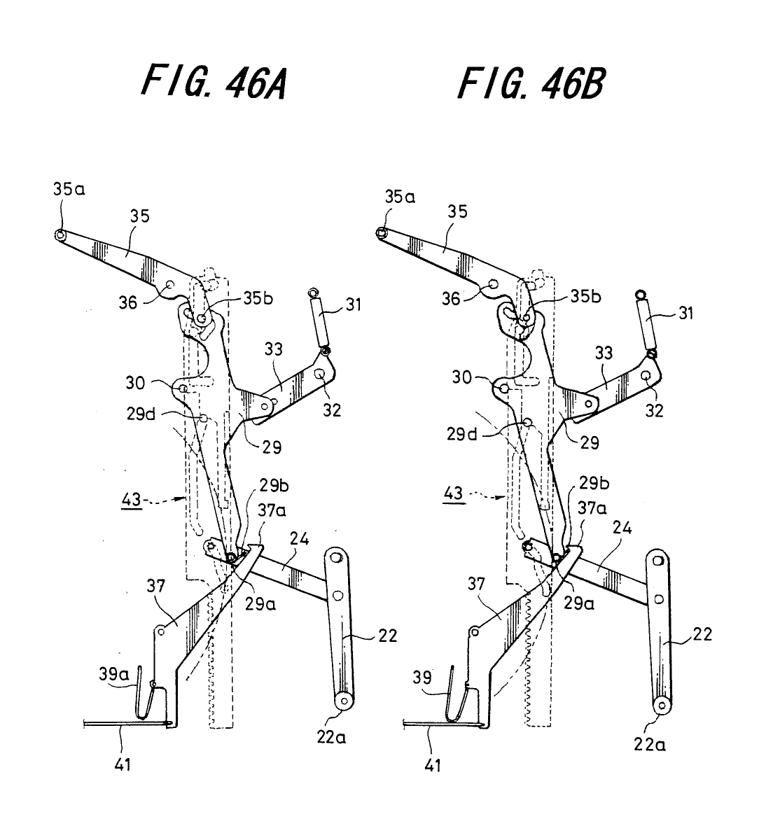

Also, when the small-diameter disc D2 is inserted into the disc apparatus 1 from the slot 3a of the front bezel 3, if the supporting member 29a of the guide arm 29 is pressed and swung in the centrifugal direction as shown in FIG. 46A, then the strip piece 29b is engaged with the angle 37a of the lock lever 37 that is placed in the static state at a predetermined position without being swung as shown in FIG. 46B so that, also in this case, it is possible to prevent the small-diameter disc D2 from being dropped out of the transport path. Specifically, the small-diameter disc D2 is guided by the supporting member 25a of the guide arm 25 and the supporting member 29a of the guide arm 29 and thereby guided to the center of the disc apparatus 1.

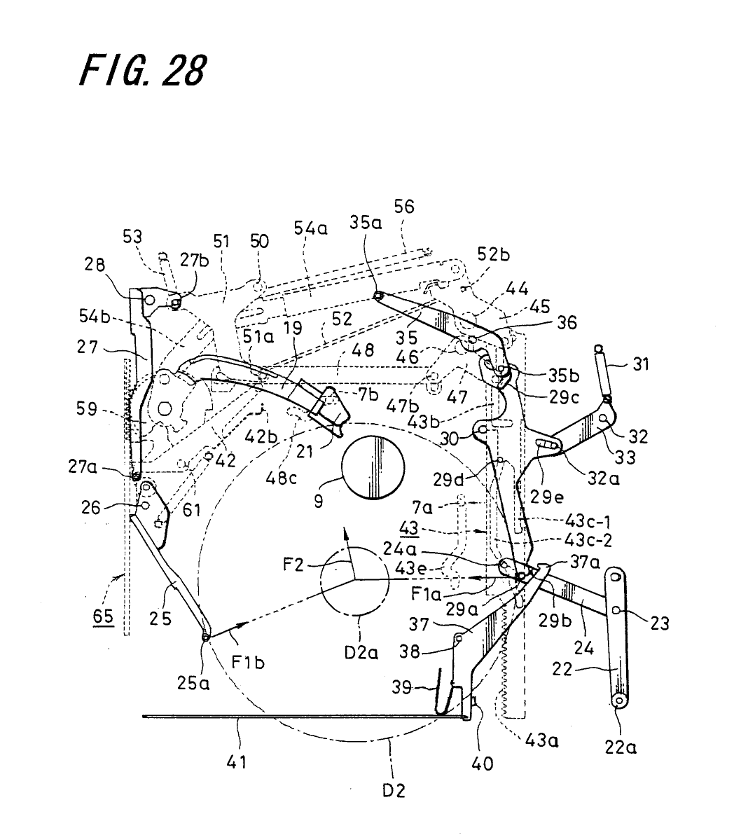

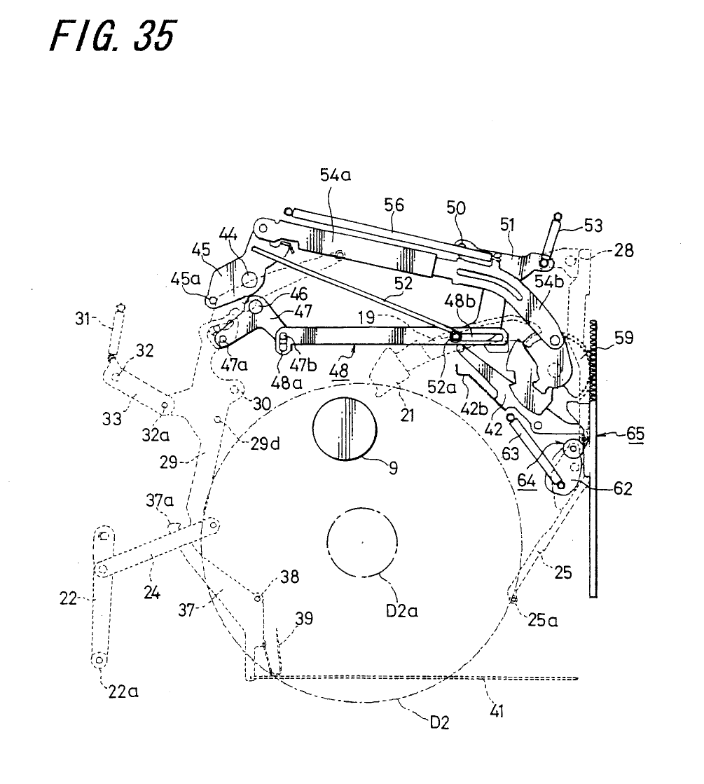

FIGS. 28 and 35 show states in which the small-diameter disc D2 is further inserted into the disc apparatus 1 by the operator from the above-described state. The disc supporting arm 19 is pressed by the small-diameter disc D2 and swung to the centrifugal direction. At the same time, the supporting member 25a of the guide arm 25 and the supporting member 29a of the guide arm 29, both of which are driven in unison with swinging of this disc supporting arm 19, are brought in contact with the side portion of the small-diameter disc D2. As a result, the small-diameter disc D2 is supported by three points of the above-described supporting members 25a, 29a and the holder 21 of the disc supporting arm 19.

Also, the base portion of the disc supporting arm 19 is rotated at the rivet pin 20 from the position shown in FIG. 42A to the position shown in FIG. 42B and the limit switch 60 is energized by the switch actuating stepped portion 59e of the gear disc 59. Based on a signal generated from the limit switch 60 energized by the above-described switch actuating stepped portion 59e, a current of low potential voltage is applied to the loading motor 66. At that time, since a component of a force F1a generated by pressing of the supporting member 29a of the guide arm 29 and a component of a force F1b generated by pressing of the action of the tension coil spring 63 of the supporting member 25a of the guide arm 25 are caused to act considerably, the resultant force F2 to drive the small-diameter disc D2 in the loading direction is generated and automatic loading of the small diameter disc D2 by the loading motor 66 is started.

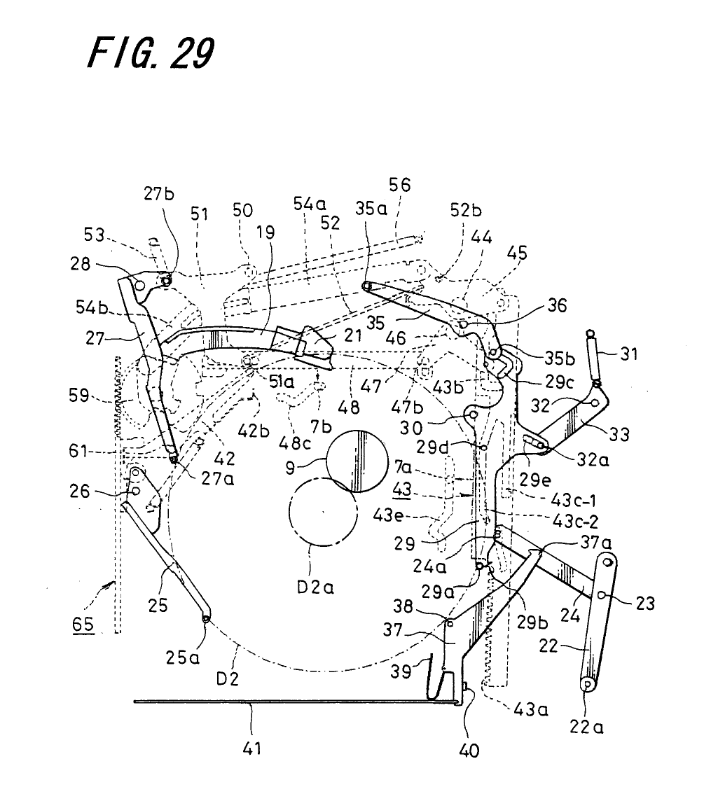

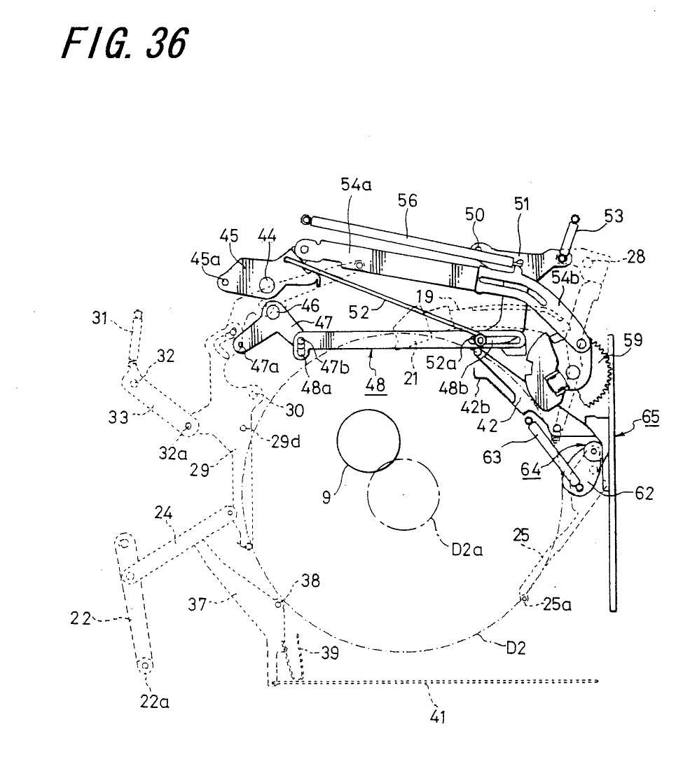

FIGS. 29 and 36 shows states in which the automatic loading of the small-diameter disc D2 by the loading motor 66 is started and in which the small-diameter disc D2 is being loaded into the disc apparatus 1. When the loading slider 43 is further moved in the backward direction from the state shown in FIG. 28, the follower pin 29d of the guide arm 29 is entered into the guide groove 43c-2 of the loading slider 43. At that time, the follower pin 29d is guided by the inclined portion of the guide groove 43c-2, it is moved by only the inclined distance and the supporting member 29a is swung up to the position shown in FIG. 36 while the small-diameter disc D2 is being loaded into the disc apparatus 1. At that time, the guide arm 25 also is swung up to the position shown in FIG. 36 owing to the action of the tension coil spring 63 while the guide arm 25 is loading the small-diameter disc d2.

When the loading slider 43 is moved backward up to the position shown in FIG. 29, concurrently therewith, the upper end horizontal portion 43b-1 of the guide groove 43b elevates the follower pin 45a of the first swing member 45 and the first swing member 45 is swung at the rivet pin 44 so that the gear disc 59 is rotated through the link arm 54. As a result, the disc supporting arm 19 is swung in the centrifugal direction, that is, the holder 21 that supports the rear end portion of the small-diameter disc D2 is moved backward in synchronism with the loading of the small-diameter disc D2. It should be noted that, since the follower pin 47a of the second swing member 47 slides the vertical portion of the guide groove 43b at this time point, the second swing member 47 is placed in the static state, the follower slider 48 also being placed in the static state.

Accordingly, since the third swing member 51 is swung owing to the action of the tension coil spring 53 as the first swing member 45 swings, the guide arm 27 is swung at the rivet pin 28 and its supporting member 27a is brought in contact with the small-diameter disc D2. It should be noted that, since the follower pin 7a of the elevation frame 7 is to be moved horizontally in the low position portion 43e-1 of the cam groove 43e and the follower slider 48 is placed in the static state, the elevation frame 7 is suddenly stopped at the position shown in FIG. 40A.

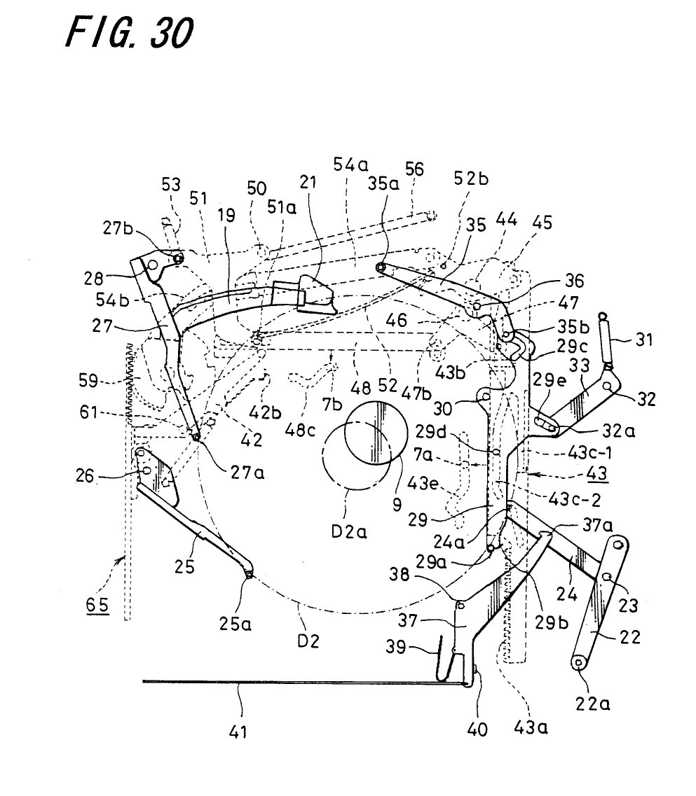

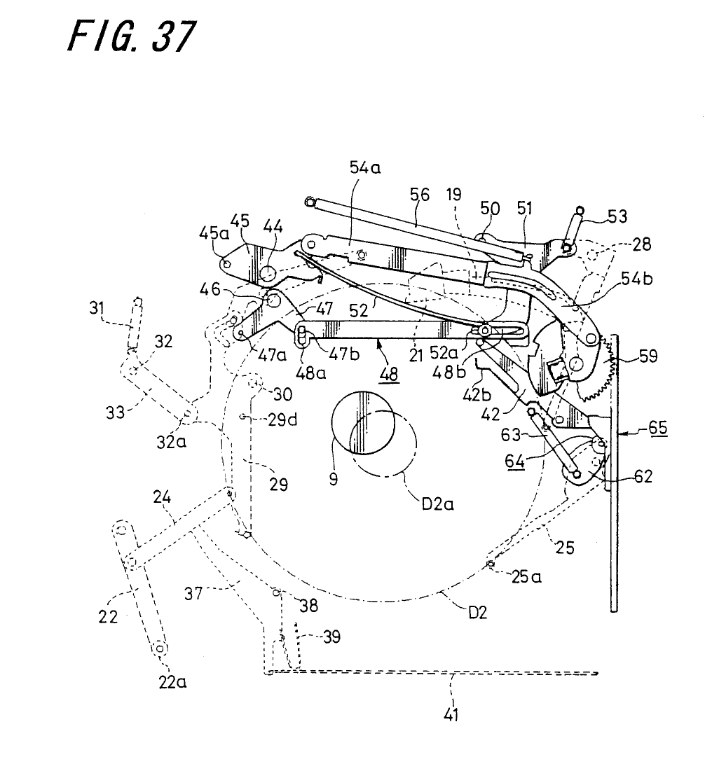

FIGS. 30 and 37 show states in which the loading slider 43 is further moved in the backward direction from the states shown in FIGS. 29 and 36 and in which the loading of the small-diameter disc D2 is being continued. Although the guide arm 29 is stopped swinging, the disc supporting arm 19 is swung in the centrifugal direction and the guide arms 25 and 27 are swung in the centripetal direction in response to the movement amount of the loading slider 43, thereby supporting the small-diameter disc D2.

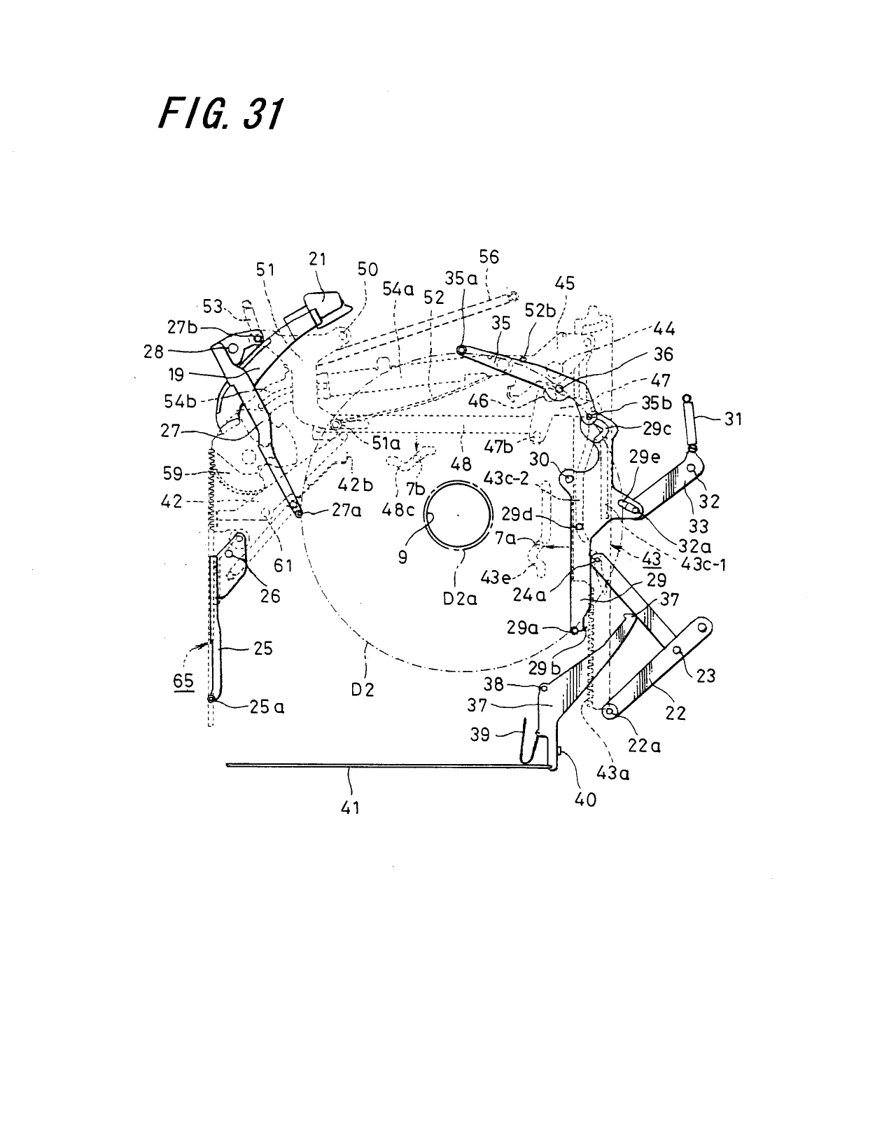

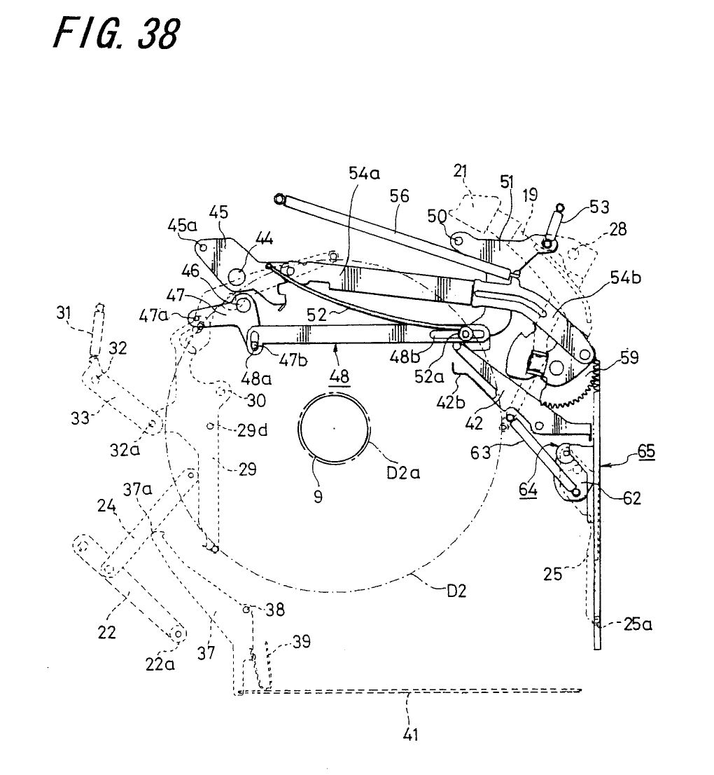

FIGS. 31 and 38 show states in which the loading slider 43 is further moved backward from the states shown in FIGS. 30 and 37 and in which the center of the central hole D2a of the small-diameter disc D2 and the center of the clamping head 9 are made coincident with each other. In the process reaching the above-described state, as the loading slider 43 is moved in the backward direction, the disc supporting arm 19 is considerably swung in the centrifugal direction to end supporting of the outer peripheral edge of the small-diameter disc D2 and this swinging causes the gear disc 59 to move the rack slider 65 in the forward direction. As a result, the small diameter portion 64b of the double roller 64 is urged against the high position guide piece 65c of the rack slider 65 so that the guide arm 25 is considerably swung in the centrifugal direction to end supporting of the outer peripheral edge of the small-diameter disc D2. In consequence, the guide arm 25 is escaped to the lateral side of the elevation frame 7 and it is placed in the state in which it is not extended over the elevation frame 7.

In the above-described state, although the outer peripheral edge of the small-diameter disc D2 is supported by three points of the supporting member 27a of the guide frame 27, the supporting member 29a of the guide arm 29 and the supporting member 35a of the guide arm 35, in the process reaching this state, pushing force generated by action of the tension coil spring 53 of the supporting member 27a of the guide arm 27 is caused to act so that loading of the small-diameter disc D2 is continued.

Also, in the process from FIGS. 30 to 31, when the cam groove 43e of the loading slider 43 is moved backward, the follower pin 7a of the elevation frame 7 is moved from the low position portion 43e-1 to the inclined portion 43e-2 and it is to be elevated. On the other hand, since the follower pin 47a of the second swing member 47 reaches from the vertical portion 43b-3 of the loading slider 43 to the lower end horizontal portion 43b-2 and this second swing member 47 is swung in the centrifugal direction, the cam groove 48c is moved horizontally as the action pin 47b moves the follower slider 48 in the horizontal direction. As a result, the follower pin 7b of the elevation frame 7 is moved from the low position portion 48c-1 to the inclined portion 48c-2 and it is to be ascended so that the elevation frame 7 starts ascending as shown in FIG. 40B.

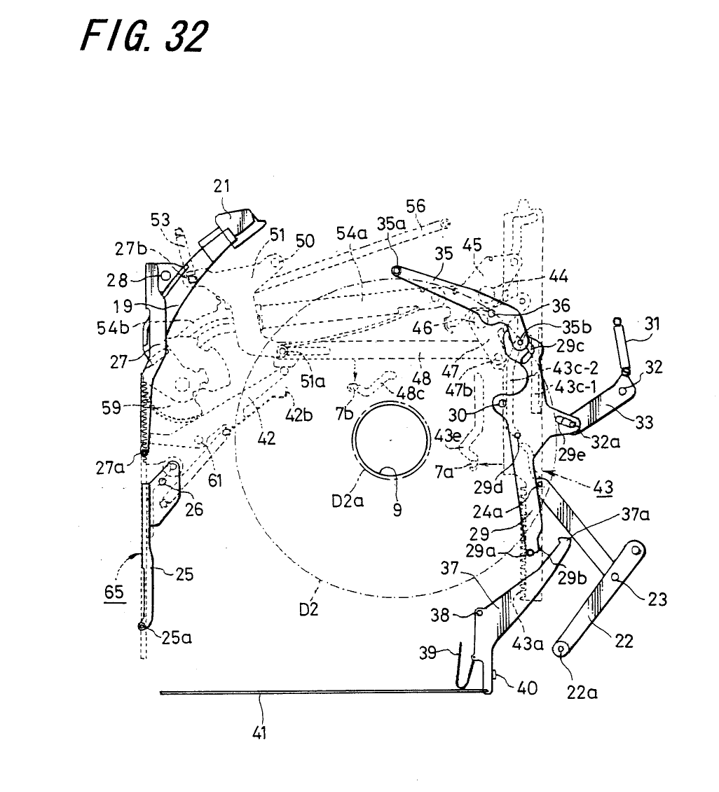

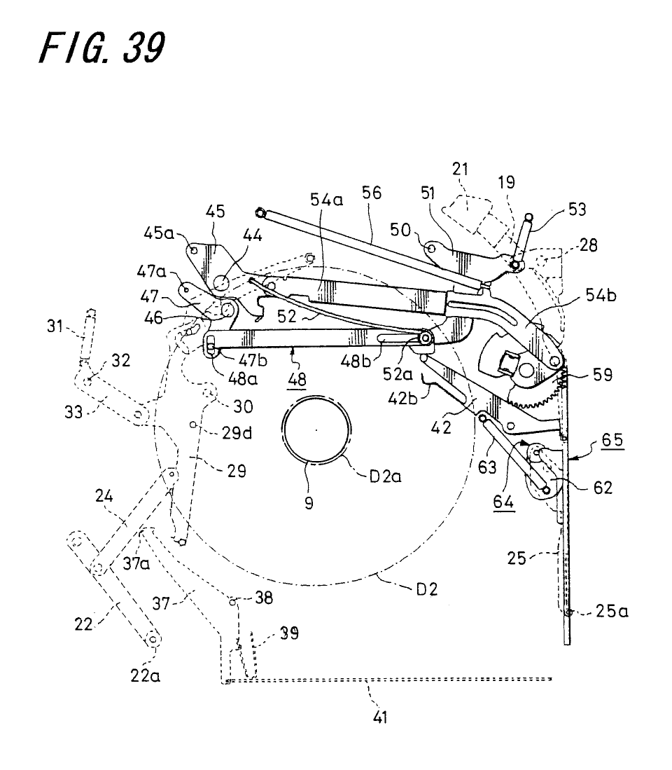

FIGS. 32 and 39 show final states in which the clamping head 9 clamps the central hole d2a of the small-diameter disc D2 and in which it becomes possible to drive the small-diameter disc D2. In order to reach this state, the guide arms 27, 29 and 35 should be swung and the supporting of the small-diameter disc D2 should be ended so as not to disturb rotation of the small-diameter disc D2.

More specifically, at the position in which loading slider 43 is further moved in the backward direction from the state shown in FIG. 31, the follower pin 47a is pushed upward by the lower end horizontal portion 43b-2 and the second swing member 47 is swung in the centrifugal direction. As a result, the action pin 51a joined to the end portion through-hole 48b of the follower slider 48 is pulled and the third swing member 51 is swung in the centripetal direction, whereby the guide arm 27 is swung in the centrifugal direction and supporting of the small-diameter disc D2 is ended.

On the other hand, since the follower pin 29d is moved to reach the inclined portion of the end of the guide groove 43c-2 of the loading slider 43, the guide arm 29 is slightly swung in the centrifugal direction and supporting of the small-diameter disc D2 by the supporting member 29a is ended. Also, owing to swinging of this guide arm 29, the follower pin 35b joined to the guide groove 29c is operated, the guide arm 35 is slightly swung in the centrifugal direction and supporting of the small-diameter disc D2 is ended.

It should be noted that, while the follower slider 48 is moved horizontally in synchronism with the backward movement of the loading slider 43 in the process from FIGS. 31 to 32, the follower pin 7a of the elevation frame 7 is moved from the Inclined portion 43e-2 to the high position portion 43e-3 of the cam groove 43e of the loading slider 43 and that the follower pin 7b is moved from the inclined portion 48c-2 to the high position portion 48c-3 of the cam groove 48c of the follower slider 48.

With respect to the behavior of the elevation frame 7 in this process, the elevation frame 7 is elevated by the follower pins 7a and 7b which are elevated by the inclined portions 43e-2 and 48c-2, as shown in FIG. 40C, the chuck claw 9a of the clamping head 9 is brought in contact with the central hole D2a of the small-diameter disc D2 to push the small-diameter disc D2 upwardly so that the peripheral edge of the central hole D2a is brought in contact with the protruded portion 2b of the chassis case 2.

When the follower pins 7a and 7b reach the tops of the inclined portions 43e-2 and 48c-2 from the above-described state, as shown in FIG. 40D, the clamping head 9 is fitted into the central hole D2a of the small-diameter disc D2 and clamping by the chuck claw 9a is completed so that the small-diameter disc D2 is fixed to the turntable 10. Then, when the follower pins 7a and 7b are moved to the high position portions 43e-3 and 48c-3, the elevation frame 7 is lowered up to the position shown in FIG. 40E and it becomes possible to drive the small-diameter disc D2.

While the operation modes in which the respective mechanisms are operated when the small-diameter disc D2 is loaded into the disc apparatus 1 according to the present invention has been described so far, when the small-diameter disc D2 is unloaded from the disc apparatus 1, the respective mechanisms are operated in the order opposite to the above-mentioned order in which the small-diameter disc D2 is loaded into the disc apparatus 1 as the loading slider 43 is moved forward. More specifically, when the unloading of the small-diameter disc D2 from the disc apparatus 1 is started and the loading slider 43 starts moving in the forward direction, the elevation frame 7 is temporarily ascended and then descended up to the initial position as shown in FIGS. 41A to 41E. During this period, the small-diameter disc D2 is pushed upwardly by the clamp releasing pin 71 as shown in FIG. 41C and the small-diameter disc D2 is released from being clamped by the clamping head 9.

In the process executed until the small-diameter disc D2 is released from being clamped by the clamping head 9 as described above, the state becomes a state shown in FIG. 31 in which the guide arms 25, 27 and 29 are swung in the centripetal direction to support the outer peripheral edge of the small-diameter disc D2. Subsequently, in the operations following the reverse order from FIGS. 30 to 27, the small-diameter disc D2 is unloaded from the disc apparatus 1 by force to swing the disc supporting arm 19 in the centripetal direction, the front end of the small-diameter disc D2 is exposed from the slot 3a of the front bezel 3 and the operation is stopped.

Since the slot-in system disc apparatus according to the present invention can support at least three portions of the outer peripheral edges of the large-diameter disc D1 and the small-diameter disc D2 by a plurality of arms operable in synchronism with forward and backward movements of the loading slider 43, it becomes possible to automatically load discs with different diameters in the arm swinging loading system.

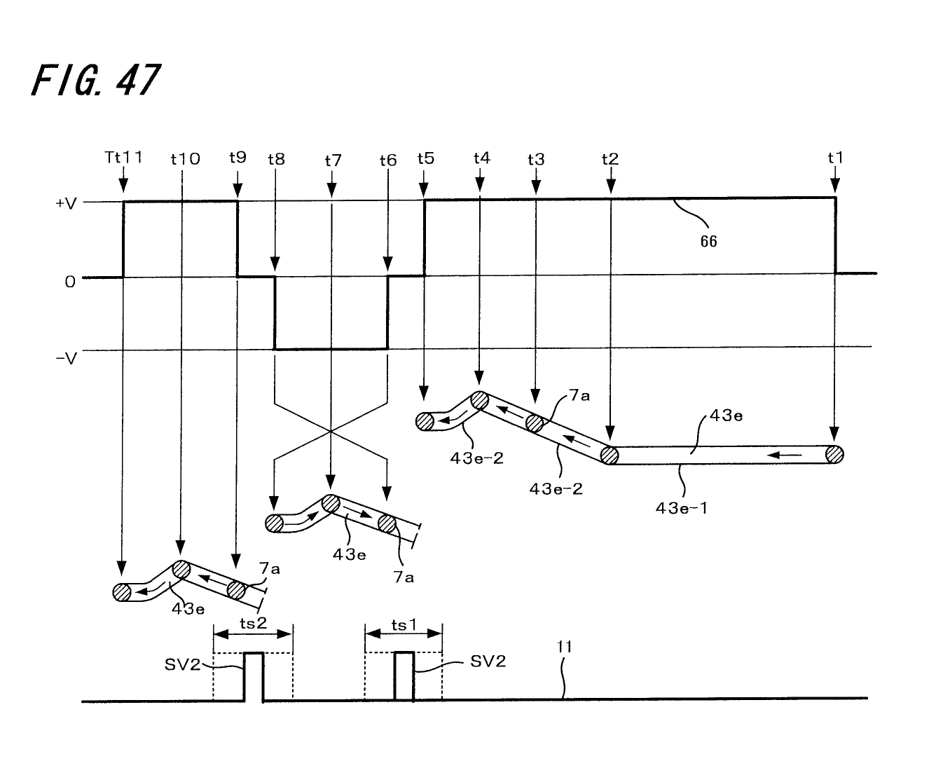

Next, arrangements and operations to clamp the large-diameter disc D1 and the small-diameter disc D2 with improved reliability by the clamping head 9 will be described as the aforementioned problem of the present invention. According to the present invention, a disc rotation angle may be changed in synchronism with clamping operations done a plurality of times by the clamping head 9. First, modes of clamping operations continuously carried out a plurality of times by the clamping head 9 will be described with reference to FIG. 47. It should be noted that the large-diameter disc D1 and the small-diameter disc D2 will be generally referred to as a “disc D” and its central hole will be generally referred to as a “central hole Da”.

In the state in which the loading slider 43 is advanced most as shown in FIG. 6, the follower pin 7a is supported by the cam groove 43e and it is placed at the starting end of the low position portion 43e-1. In such state, when the supply of positive potential (+V) to the loading motor 66 is started (t1) as the automatic loading is started, the loading slider 43 starts moving in the backward direction to start loading of the inserted disc D.

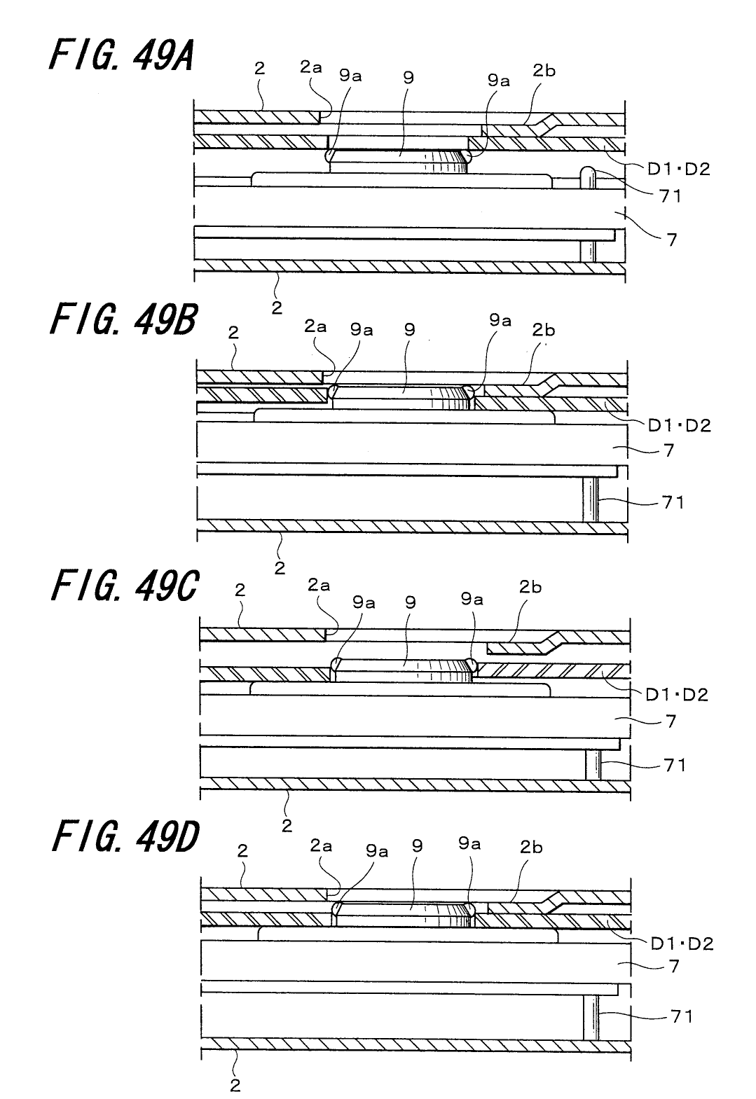

When the follower pin 7a passes the low position portion 43e-1 of the cam groove 43e and reaches the inclined portion 43e-2 (t2) to receive action of the inclined portion 43e-2, the follower pin 7a, that is, the elevation frame 7 starts ascending and reaches the position (see t3/FIG. 49A) at which the chuck claw 9a of the clamping head 9 contacts with the central hole Da of the disc D. Then, when the follower pin 7a reaches the top of the inclined portion 43e-2, the first clamping operation of the disc D by the clamping head 9 is completed (see t4/FIG. 9B) and the follower pin 7a descends and reaches the final position of the high position portion 43e-3 (see t5/FIG. 49C).

When the first clamping operation of the disc D is completed as described above and the follower pin 7a starts descending from the top portion of the cam groove 43e, the clamping head 9 starts descending concurrently therewith, the central hole Da of the disc D starts moving away from the protruded portion 2b of the chassis case 2. Then, after a very short time period (t5 to t6) in which a voltage is not supplied to the loading motor 66 in order to protect the loading motor 66 passed, the supply of a negative voltage (−V) to the loading motor 66 is started (t6).

In this manner, when the supply of the negative voltage (−V) to the loading motor 66 is started, the loading motor 66 starts rotating in the reverse direction and the loading slider 43 starts moving in the forward direction to cause the clamping head 9 to start ascending again. Then, at a proper time during a time period (ts1), a very small actuating voltage SV1 is applied to the spindle motor 11 to rotate the disc D at a predetermined angle (for example, 180°) that has been set previously. It should be noted that a time at which the above-described actuating voltage SV1 is applied to the spindle motor 11 may be set within a timing which falls within the above-described time period ts1. More specifically, the above-mentioned time is set so as to fall within a period before and/or after the loading motor 43 is rotated in the reverse direction and within the period in which the central hole Da of the disc D is spaced apart from the protruded portion 2b of the chassis case 2.

When the clamping head 9 may not clamp the disc D with reliability in the above-described first clamping operation to generate a gap g between the turntable 10 and the disc D as shown in FIG. 49B, the portion in which the above-described gap g is generated is moved to the position opposing the protruded portion 2b of the chassis case 2 as the disc D is rotated based on the above-described actuating voltage SV1 as shown in FIG. 49C.

In this manner, since the clamping head 9 ascends more after the disc D was rotated, the second clamping operation is carried out (t7). Therefore, the disc D placed at the portion in which the gap g is generated as shown in FIG. 49C is pushed by the protruded portion 2b of the chassis case 2 as shown in FIG. 49D and hence the disc D can be clamped by the clamping head 9 with reliability. It should be noted that the time period (t6 to t8) in which the negative voltage (−V) is applied to the loading motor 66 may be set within a range wide enough for the clamping head 9 to move up and down to clamp the disc D.

In this manner, after the second clamping operation is ended, the follower pin 7a returns to the position of the time period t8 and it is necessary to bring the follower pin 7a back to the final position of the high position portion 43e-1 again. Therefore, when the supply of the negative voltage (−V) to the loading motor 66 is interrupted (t8), after the very short time period (t8 to t9) in which the voltage is not supplied to the loading motor 66 in order to protect the loading motor 66 passed, the positive voltage (+V) is supplied to the loading motor 66. Then, when the supply of the positive voltage (+V) to the loading motor 66 is started (t9), the loading motor 66 starts rotating in the positive direction to allow the loading slider 43 starts moving backward and the clamping head 9 starts ascending again.

Then, at a proper time within the period (ts2), a very small actuating voltage SV2 is applied to the spindle motor 11 to thereby rotate the disc D at a predetermined angle. It should be noted that, also in this case, a time in which the above-described actuating voltage SV2 is applied to the spindle motor 11 may be set to a timing which falls within the above-described time period ts2. More specifically, the above-described time may be set to a time period before and/or after the period in which the loading slider 43 is rotated in the reverse direction and a time period in which the central hole Da of the disc D is spaced apart from the protruded portion 2b of the chassis case 2.

In this manner, after the disc D was rotated, the clamping head 9 further ascends to carry out the third clamping operation (t10). Accordingly, even when the disc D was not clamped by the second clamping operation with reliability, clamping of the disc D can be improved in reliability by the third clamping operation.

While the above explanation is based on the example in which the very short time periods (t5 to t6 and t8 to t9) in which the voltage is not supplied to the loading motor 66 are provided when the loading slider 43 is rotated in the reverse direction, the present invention is not limited thereto and the operation speed of the disc apparatus may be increased by continuously supplying the voltages to the loading motor 66 in the sequential order of the positive voltage, the negative voltage and the positive voltage.

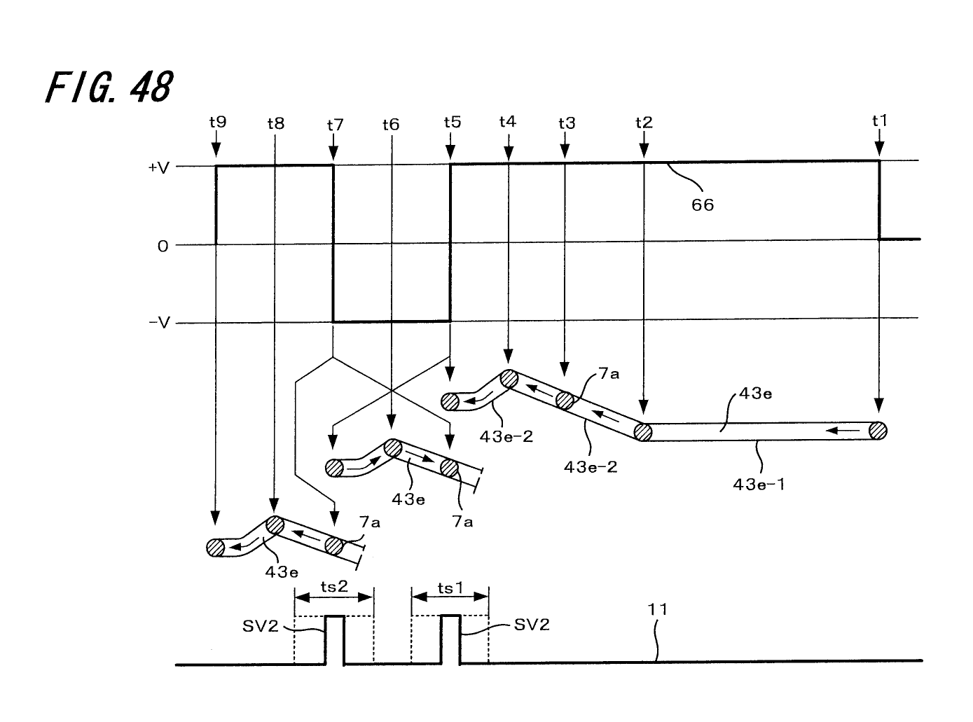

FIG. 48 shows the state in which the loading slider 43 is immediately operated in the reverse direction by immediately switching the positive and negative voltages (t5 and t7). As a result, as shown in FIG. 47, it is possible to absorb a timing loss generated when the very short time periods (t5 to t6 and t8 to t9) are provided. Also in this case, the actuating voltages (SV1 and SV2) are applied to the spindle motor 11 to rotate the disc D at a predetermined angle during the time periods (ts1 and ts2) in which the central hole Da of the disc D is spaced apart from the protruded portion 2b of the chassis case 2. Also in this case, times in which the above-described actuating voltages (SV1 and SV2) are applied to the spindle motor 11 may be set to timings which may fall within the above-described periods (ts1 and ts2).

Meanwhile, if the values of the above-described actuating voltages SV1 and SV2 are identical relative to the large-diameter disc D1 and the small-diameter disc D2, then even when a predetermined rotation angle is obtained in the large-diameter disc D1, such predetermined rotation angle becomes an excessive rotation angle for the small-diameter disc D2. Also, conversely, when a predetermined rotation angle is obtained in the small-diameter disc D2, such rotation angle becomes too small for the large-diameter disc D1. The reason for this will be described. That is, since the large-diameter disc D1 and the small-diameter disc D2 are considerably different from each other in mass, if the voltage values of the actuating voltages SV1 and SV2 applied to both of the large-diameter disc D1 and the small-diameter disc D2 are identical, then different inertias are generated in the discs when they are rotated with the result that both of the large-diameter disc D1 and the small-diameter disc D2 come to halt at different rotation angles. Then, when an excessive rotation angle is obtained, that is, when a rotation angle obtained after the actuation voltages SV1 and SV2 were applied reaches 360°, the static state of the disc becomes the state shown in FIG. 48B again and hence reliable clamping operation may not be expected.

Then, according to the present invention, it is determined whether the inserted disc is the large-diameter disc D1 or the small-diameter disc D2. Magnitudes of the actuating voltages SV1 and SV2 applied to the spindle motor 11 may be controlled so as to correspond to respective discs. Therefore, any of the large-diameter disc D1 and the small-diameter disc D2 can be rotated at a predetermined rotation angle so that reliable clamping operation may be made possible. An arrangement for identifying the kind of the inserted disc in order to realize the above-mentioned function will be described below.

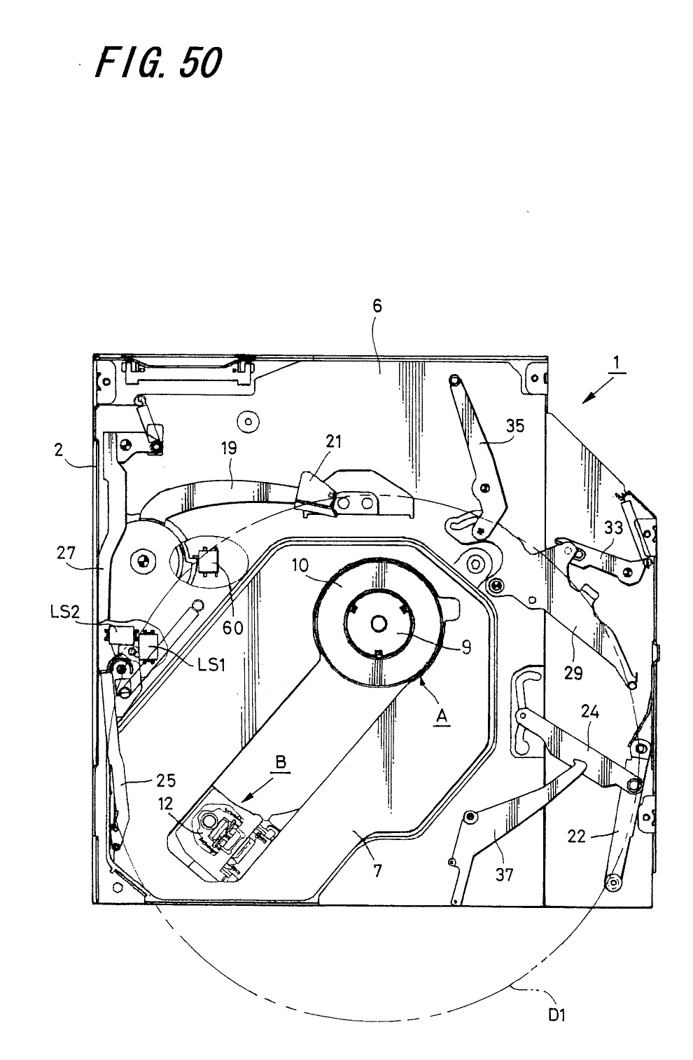

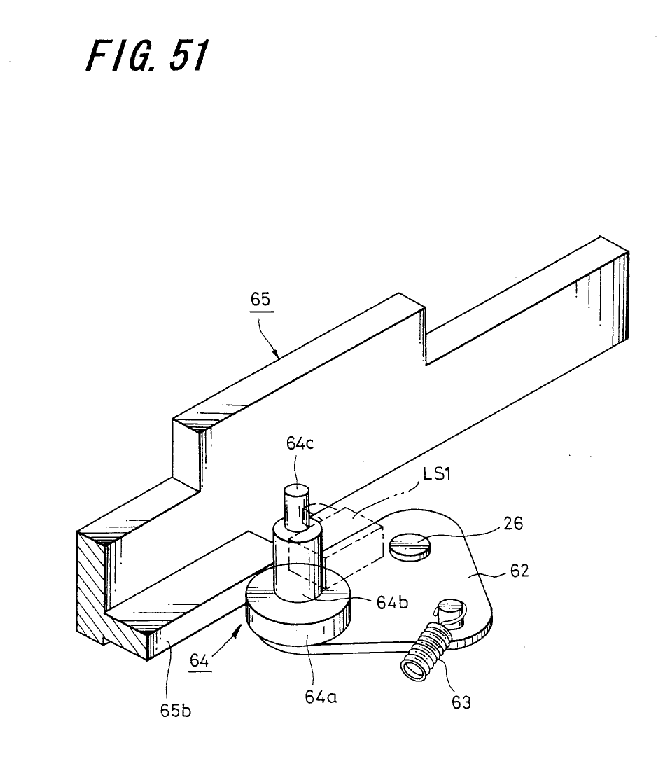

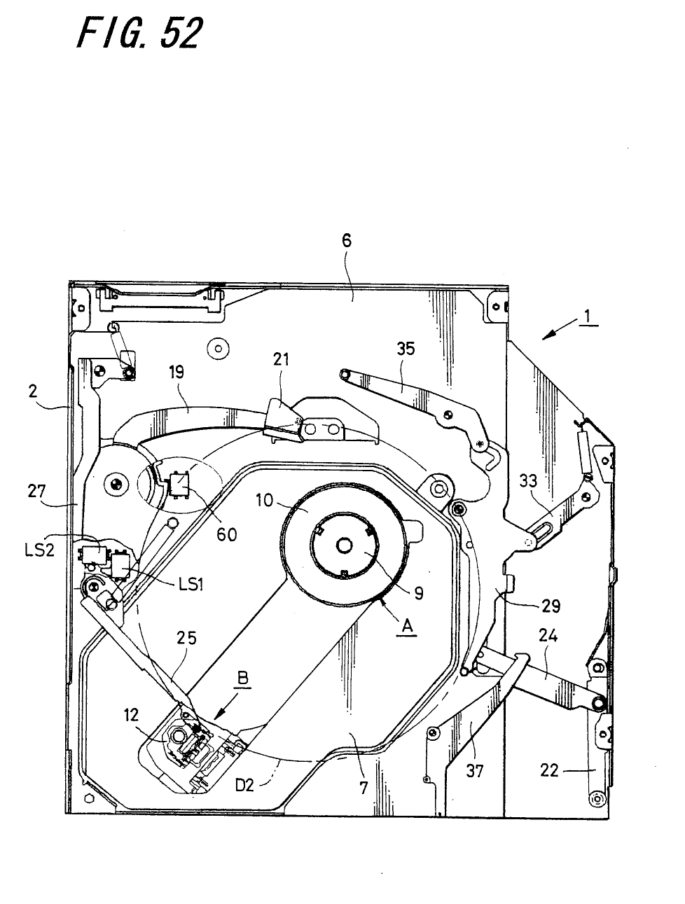

FIG. 50 is a plan view showing an arrangement in which the above-mentioned disc apparatus 1 of the present invention includes limit switches LS1 and LS2 and FIG. 51 is a perspective view showing this portion in which the limit switches LS1 and LS2 are provided in an enlarged-scale. As shown in FIGS. 50 and 51, the limit switches LS1 and LS2 of which switch knobs are operated by the action pin 64c are provided in the action pin 64c extended from the small-diameter portion 64b of the double roller 64. As shown in FIG. 50, in the state in which the large-diameter disc D1 is inserted from the slot 3a of the front bezel 3 and is automatically loaded into the disc apparatus 1, the limit switch LS1 is actuated. In the state in which the small-diameter disc D2 is inserted from the slot 3a of the front bezel 3 into the disc apparatus 1 and is automatically loaded onto the disc apparatus 1 as shown in FIG. 52, the limit switch LS2 is actuated.

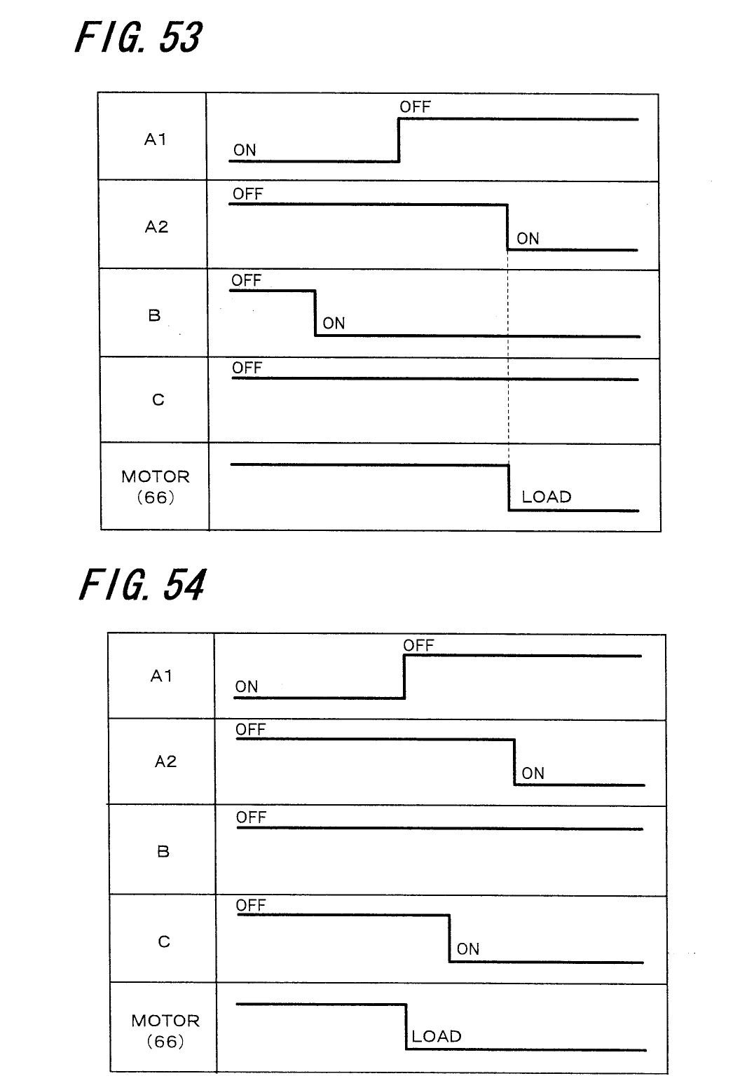

It is possible to determine based on the actuated states of the thus provided limit switches LS1, LS2 and the limit switch 60 whether an inserted disc is the large-diameter disc D1 or the small-diameter disc D2. More specifically, in FIG. 53, reference numeral A1 assumes a signal which is generated from the limit switch 60 when the limit switch 60 is energized by the switch actuating stepped portion 59e of the gear disc 59 and reference numeral A2 assumes a signal generated from the limit switch 60 when the limit switch 60 is energized by the switch actuating stepped portion 59f of the gear disc 59. Also, reference letter B assumes a signal generated from the limit switch LS1 when the limit switch LS1 is energized and reference letter C assumes a signal generated from the limit switch LS2 when the limit switch LS2 is energized.

Then, the states in which signals are generated from the respective limit switches are judged at a point of time in which automatic loading is started and such states may be compared with previously-determined coincident conditions. FIG. 53 shows states of signals obtained in the process up to automatic loading from insertion of the large-diameter disc D1. When the large-diameter disc D1 is inserted into the disc apparatus 1 from the slot 3a of the front bezel 3, the guide arm 25 swings in the centrifugal direction to energize the limit switch LS1 to change the signal B from OFF to ON. Also, when the large-diameter disc D1 is inserted into the disc apparatus 1, the guide arm 25 does not swing in the centripetal direction and the limit switch LS2 is not energized. As a result, the signal C is held at the OFF state.

On the other hand, if the limit switch 60 is energized by the switch actuating stepped portion 59e when the gear disc 59 rotates as the disc supporting arm 19 swings in the centrifugal direction, then the signal A1 is changed from ON to OFF. However, it is determined based on the condition that the signal B from the limit switch LS1 which has been energized previously is changed from OFF to ON that the inserted disc is the large-diameter disc D1. Hence, at this time point, a driving current is prevented from being applied to the loading motor 66. Then, when the gear disc 59 further rotates to allow the switch actuating stepped portion 59f to energize the limit switch 60 again, the signal A2 is changed from OFF to ON. Under this condition, a driving current is applied to the loading motor 66 to start automatic loading of the large-diameter disc D1.

FIG. 54 shows states of signals generated when the small-diameter disc D2 1s loaded into the disc apparatus 1 automatically. As mentioned hereinbefore, automatic loading of the small-diameter disc D2 is started based on the signal A1 generated from the limit switch 60 when the limit switch 60 is energized by the switch actuating stepped portion 59e of the gear disc 59. At that time, the guide arm 25 swings in the centripetal direction and does not swing in the centrifugal direction so that the signal from the limit switch LS1 constantly becomes OFF.

As described above, the states in which respective signals are generated become different when the large-diameter disc D1 is inserted into the disc apparatus 1 and the small-diameter disc D2 is inserted into the disc apparatus 1. For example, if the signal B of the limit switch LS1 is ON when the signal A1 from the limit switch 60 changes from ON to OFF, then it is possible to determine that the large-diameter disc D1 is inserted into the disc apparatus 1. Also, if the above-described signal B is OFF, then it is possible to determine that the small-diameter disc D2 is inserted into the disc apparatus 1.

It should be noted that if the signal B from the limit switch LS1 is ON when the signal A2 from the limit switch 60 changes from OFF to ON, then it can be determined that the large-diameter disc D1 is inserted into the disc apparatus 1, if the signal C from the limit switch LS2 is ON, then it can be determined that the small-diameter disc D2 is inserted into the disc apparatus 1 and that if the above-described signals B and C are both OFF, then it can be determined that error occurred and processing may be canceled.

Next, standards in which the actuating voltages SV1 and SV2 applied to the spindle motor 11 based on the judged results of the kind of the inserted disc are set will be described. As described above, since mass of the large-diameter disc D1 and that of the small-diameter disc D2 are considerably different from each other, inertias obtained when they rotate become different from each other. Accordingly, in order to rotate the large-diameter disc D1 at a predetermined rotation angle, a relative large voltage is applied to the spindle motor 11 as compared with the case to rotate the small-diameter disc D2 and a relatively small voltage is applied to the spindle motor 11 in order to rotate the small-diameter disc D2 at a predetermined rotation angle as compared with the case to rotate the large-diameter disc D1.

It should be noted that, in the above explanation, the angle at which the actuating voltages SV1 and SV2 are applied to the spindle motor 11 to rotate the clamping head 9 is not limited to the illustrated angle of 180° and may be set properly such as when the clamping head 9 may be rotated 120° during the first clamping operation and the second clamping operation and the clamping head 9 may further be rotated 120° during the second clamping operation and the third clamping operation and when the clamping head 9 may be rotated 180° during the first clamping operation and the second clamping operation and the clamping head 9 may be rotated 90° during the second clamping operation and the third clamping operation.

Also, while the spindle motor 11 is controlled based on the magnitude of the voltage values of the actuating voltages SV1 and SV2, the spindle motor 11 can be controlled based on a duration of a time in which the actuation voltages SV1 and SV2 are applied to the spindle motor 11 and both of the magnitude and the duration of time can be used as parameters. Also, while a disc can be accurately rotated at a predetermined angle by closed servo, a disc can be controlled based on open servo, which can alleviate firmware and hardware, by a combination of the above-described parameters. In actual practice, it is possible to accurately rotate a disc at a predetermined angle by monitoring an FG (Frequency Generator) of the spindle motor 11. It was confirmed that the spindle motor 11 could be controlled within a range of error of ±4° by using rotation control based on speed feedback of a three-phase motor.

Having described preferred embodiments of the invention with reference to the accompanying drawings, it is to be understood that the invention is not limited to those precise embodiments and that various changes and modifications could be effected therein by one skilled in the art without departing from the spirit or scope of the invention as defined in the appended claims.

What is claimed is:

1. A disc apparatus capable of automatic loading to load a disc into the inside of the apparatus and to unload a disc accommodated within the apparatus to the outside of the apparatus comprising:
a plurality of arms for supporting outer peripheral edges of two kinds of discs with different diameters so that said two discs can be transported;
a loading slider;
a clamping head moved up and down a plurality of times to clamp a disc by said loading slider when said loading slider is repeatedly moved forward and backward; and
a spindle motor for rotating said clamping head, wherein said spindle motor is driven by driving force previously set in response to the kind of the inserted disc at a proper time of period when said clamping head clamps the disc and which period is a period before and/or after said loading slider is moved in the reverse direction to thereby rotate the disc at a predetermined angle.

2. A disc apparatus according to claim 1, wherein said driving force for driving said spindle motor is set based on a voltage value of a voltage applied to said spindle motor and/or duration of time in which a voltage is applied to said spindle motor.

3. A disc apparatus according to claim 1, further comprising a switch for identifying the kind of an inserted disc, wherein the driving force for driving said spindle motor is selected based on an output signal from said switch.

4. A disc apparatus capable of automatic loading to load a disc into the inside of the apparatus and to unload a disc accommodated within the apparatus to the outside of the apparatus comprising:
a plurality of arms for supporting outer peripheral edges of two kinds of discs with different diameters so that said two discs can be transported;
a chassis case;
a loading slider;
a clamping head moved up and down a plurality of times to clamp a disc by said loading slider when said loading slider is repeatedly moved forward and backward; and
a spindle motor for rotating said clamping head, wherein when a clamping operation to move a disc away from a chassis case by lowering said clamping head after a disc was brought in contact with said chassis case by elevating said clamping head is carried out a plurality of times, said spindle motor for rotating said clamping head is driven by driving force previously set in response to the kind of an inserted disc to rotate a disc at a predetermined angle at a proper time of said clamping operation period and which is a period in which a disc is spaced apart from said chassis case.
